(19) United States
(12) Patent Application Publication
(10) Pub. No.: US 2001/0009427 A1
(43) Pub. Date: Jul. 26, 2001

(54) Navigation apparatus and recording medium providing communication between applications

(76) Inventors: Kazuma Kaneko, Tokyo, JP (US); Mitsuo Shimotani, Tokyo (JP); Masaharu Umezu, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/764,439

(22) Filed: Jan. 19, 2001

(30) Foreign Application Priority Data
Jan. 25, 2000 (JP) 2000-16246

(51) Int. Cl. G06F 3/00

(52) U.S. Cl. 345/854; 345/810

(57) ABSTRACT

A navigation application module providing navigation services communicates with a distribution application module to exchange data so that collection and delivery information services using navigation services are provided without user intervention.

### BACKGROUND OF THE INVENTION

1. Field of the Invention

The present invention generally relates to navigation apparatuses and recording mediums for providing navigation services such as current position computation, route search and route guidance and, more particularly, to a navigation apparatus and a recording medium in which communication between applications is provided.

2. Description of the Related Art

A navigation apparatus currently in use is usually provided with functions of, for example, displaying a current position and showing a route to a destination for a driver. Various types of navigation apparatuses provided with extended functions in addition to the basic navigation services are also being developed. Apparatuses with such extended functions are expected to find applications in the intelligent transport system (ITS). The extended functions adapted for the delivery and collection business operation include display of information related to collection and delivery of goods and received from a distribution center and information related to facilities at a delivery destination. The extended functions adapted for the general consumer market include display of information related to facilities such as restaurants at destinations.

Japanese Laid-Open Patent Application No. 11-211489 discloses executing a Java virtual machine on a platform of an ordinary navigation apparatus and adding Java applications as part of the extended functions.

FIG. 20 is a block diagram showing an on-vehicle hardware construction of a navigation apparatus according to the related art. The related-art navigation apparatus includes a read-only memory (ROM) 501 that stores programs such as a navigation operating system (OS), a device driver, a navigation application module and a distribution application module (application adapted for physical distribution of goods). Reference numeral 2 indicates a microprocessor for executing programs such as the navigation OS, the device driver, the navigation application module and the distribution application module. Reference numeral 3 indicates a random access memory (RAM) for temporarily storing programs and data while the navigation OS, the device driver, the navigation application module or the distribution application module is being executed.

A digital versatile disk(DVD)-ROM drive 4 drives a DVD-ROM disk 21 and reads data therefrom. A DVD-ROM interface 5 is used to exchange data between the DVD-ROM drive 4 and the microprocessor 2. A graphic control circuit 6 stores image data in a frame buffer 7 in accordance with an image processing instruction from the microprocessor 2 and draws an image corresponding to the image data on a display 8 such as a liquid crystal display. A user operation unit 9 is implemented by, for example, a remote controller or switches. An operation unit interface 10 is used to exchange data between the user operation unit 9 and the microprocessor 2.

A global positioning system (GPS) 11 receiver receives radio waves from GPS artificial satellites. A vehicle speed pulse counter 12 is provided, for example, at a vehicle shaft and measures the speed of a vehicle. A gyro 13 detects the orientation of the vehicle. A peripheral interface 14 exchanges data between the GPS receiver 11, the vehicle speed pulse counter 12, the gyro 13 and the microprocessor 2.

A portable telephone set 15 connects to a distribution center 32 or the Internet 33 via a portable telephone network. A communication interface 16 controls the portable telephone set 15 to perform data communication and exchanges data with the microprocessor 2.

A DVD-ROM 21 stores a map database and the like. Also provided in the related-art navigation apparatus are: a speaker for outputting audio guidance and a driving circuit for driving the same; and a multiplex FM receiver, a radio beacon/light beacon receiver or the like for communicating with an external infrastructure.

FIG. 21 shows a hierarchical construction of the related-art navigation apparatus. Referring to FIG. 21, navigation hardware 41 comprises the microprocessor 2, the DVD-ROM drive 4, the display 8, the user operation unit 9, the GPS receiver 11 and the portable telephone set 15. A navigation OS 42 is provided with basic functions of controlling the navigation hardware 41. A device driver 43 directly controls the navigation hardware 41. The navigation hardware 41, the navigation OS 42 and the device driver 43 constitute a platform block.

The hierarchy further comprises: a Java virtual machine 44 that operates on the navigation OS 42; and a distribution application module 545 that provides various services required in the collection and delivery operation (hereinafter, such services will be referred to as collection and delivery information services). The distribution application module 545 is a JAVA application and operates on the JAVA virtual machine 44. A navigation application module 546 provides navigation services by executing computation of a current position, computation of a route, guidance of a route, display of a map and the like, based on information from the navigation hardware 41. The navigation application module 546 is developed a program language such as C or C++ and implemented in the navigation apparatus in the form of native codes.

A description will now be given of the operation according to the related art.

FIG. 22 shows an example of a vehicle operation instruction provided from the distribution center 32 to the related-art navigation apparatus. FIG. 23 shows an example of menu display of collection and delivery information services provided in the related-art navigation apparatus.

The navigation OS 42, the device driver 43, the JAVA virtual machine 44, the distribution application module 545 and the navigation application module 546 are started by the microprocessor 2. The data acquired or generated in the process of execution is stored in the RAM 3.

After the programs are started, the navigation application module 546 processes events (for example, user setting of a destination or an instruction to display a map) related to navigation services and generated in the navigation hardware 41. For example, the navigation application module 546 operates to provide navigation service by displaying a guidance image on the display 8 or output audio guidance from a speaker (not shown).

The distribution application module 545 is executed on the JAVA virtual machine 44 so as to read an vehicle operation instruction as shown in FIG. 22 provided by the distribution center 32 and picked up by the portable telephone set 15, display a menu listing the collection and delivery information services on the display 8, and processes events generated by a user's selection on the menu. Thus, the distribution application module 545 provides a selected collection and delivery service based on the vehicle operation instruction in a manner independent of the navigation service. The user may be a driver of the vehicle or a person accompanied by the driver.

As shown in FIG. 22, the vehicle operation instruction may include vehicle information; order or delivery and locations of delivery destination; and operations required at the destination. The vehicle information may include information related to vehicle identification, a driver and the like. The order of delivery and locations of delivery may be specified as a list of store codes, store names and store locations (addresses) arranged in the order of delivery. The list also includes time of delivery and indication of whether there is a request for a time of delivery. The operations required at the destination may be specified as a list of names of delivered goods and the quantity thereof at each of the delivery destinations.

As shown in FIG. 23, the menu of collection and delivery information services is displayed in an area 601 of the screen of the display 8. A map provided by the navigation services is displayed in a remaining area 602.

The menu of collection and delivery information services shown in FIG. 23 includes the following menu items: “vehicle operation instruction reception” item 621, “delivery schedule” item 622, “delivery destination information” item 623, “delivered goods” item 624; and “status input” item 625. A cursor is moved in accordance with the user operation provided via the user operation unit 9 such as a remote controller or operation buttons (not shown). Information related to the selected item is delivered to the distribution application module 545 so that the collection and delivery information service corresponding to the item is provided by the distribution application module 545.

When the “vehicle operation instruction reception” item 621 is selected by the user, the distribution application module 545 responds to the selection by controlling the communication interface 16 and the portable telephone set 15, which constitute the navigation hardware 41, via the JAVA virtual machine 44, the navigation OS 42 and the device driver 43, so as to read out the vehicle operation instruction as shown in FIG. 22 from the distribution center 32. The vehicle operation instruction data is temporarily stored in the RAM 3.

When the “delivery schedule” item 622 is selected by the user, the distribution application module 545 responds to the selection by selectively reading the vehicle operation instruction stored in the RAM 3. More specifically, the distribution application module 545 reads out the order of delivery, the names of the stores at the respective destinations, the requested time of delivery and indication of whether a time of delivery is requested, for all destinations. The distribution application module 545 controls the graphic control circuit 6 via the Java virtual machine 44, the navigation OS ad the device driver 4 so as to display the information thus read out on the display 8.

When the “delivery destination information” item 623 is selected by the user, the distribution application module 545 responds to the selection by selectively reading the vehicle operation instruction stored in the RAM 3. More specifically, the distribution application module 545 reads out the order of delivery, the names of the stores, the locations (addresses) of the delivery destinations, for all destinations. The distribution application module 545 controls the graphic control circuit 6 via the Java virtual machine 44, the navigation OS 42 and the device driver 43 so as to display the information thus read out on the display 8.

When the “delivered goods” item 624 is selected by the user, the distribution application module 545 response to the selection by selectively reading the vehicle operation instruction stored in the RAM 3. More specifically, the distribution application module 545 reads out the names of the stores at the respective destinations, the names of goods to delivered and the quantity thereof, for all destinations. The distribution application module 545 controls the graphic control circuit 6 via the Java virtual machine 44, the navigation OS ad the device driver 43 so as to display the information thus read out on the display 8.

When the “status input” item 625 is selected by the user, the distribution application module 545 responds to the selection by selectively reading the vehicle operation instruction stored in the RAM 3. More specifically, the distribution application module 545 reads out the order of delivery and the names of the stores at the respective destinations so as to sequentially display on the display 8 the names of the stores in the order of delivery, by controlling the graphic control circuit 6 via the Java virtual machine 44, the navigation OS 42 and the device driver 43. Buttons labeled “arrival”, “departure”, “being delivered” and “taking a rest” are also displayed on the display 8 for input of a current status.

When the user presses one of the buttons, associated information is supplied via the user operation unit 9 to the distribution application module 545. The distribution application module 545 controls the communication interface 16 and the portable telephone set 15, which constitute the navigation hardware 41, via the Java virtual machine 44, the navigation OS 42 and the device driver 43. Accordingly, the current status corresponding to the selected button and data related to the destination are supplied to the distribution center 32. Thereby, the distribution center 32 can keep track of the current status of the vehicle and how the operation is proceeding.

A description will now be given of an example of how a user at the collection and delivery operation operates the related-art navigation apparatus.

The user initially selects the collection and delivery information service provided by the distribution application module 545 by selecting the “vehicle operation instruction reception” item 621 at the top of the menu so as to acquire the vehicle operation instruction from the distribution center 32.

The user subsequently selects the “destination information” item 623 in the menu so as to learn the name of the store at the first delivery destination and the address thereof.

The user registers the address of the first delivery destination as a target destination in the navigation service provided by the navigation application module 546. This prompts route guidance to the first delivery destination to be executed.

When the user arrives at the first delivery destination, the user selects the “status input” item 625 in the menu and presses the “arrival” button. As a result of this, the distribution center 32 is notified of the name of the store at the first delivery destination and the fact that the user arrives there.

When the operation at the first destination is completed, the user selects the “status input” item 625 in the menu and presses the “departure” button. This causes the distribution center 32 to be notified of the name of the first store and the fact that the user left there.

A similar process is performed in subsequent delivery destinations. The user uses the collection and delivery information services to learn the name of the store and the address thereof, registers the address in the navigation service so as to receive route guidance that guides the user to the destination. The user uses the collection and delivery information service to notify the distribution center 32 of the fact that the user arrives at the destination or leaves the destination.

In the related-art navigation apparatus described above, the navigation application module that executes navigation services and the distribution application module that executes collection and delivery information services operate independently. The user requesting the navigation service for a delivery destination has to register a target destination for each collection or delivery destination. This imposes a complex operation on the user at the collection and delivery operation who is to receive the navigation service. Accordingly, it is difficult to improve the efficiency of collection and delivery operation. A similar situation occurs in areas other than the collection and delivery operation. The same difficulty is encountered when an application module providing other optional services is used in combination with the navigation service.

Since the user has to confirm the name of the store at the delivery destination before notifying the distribution center of the current status of collection and delivery, a complex user operation is imposed, thus providing another reason why it is difficult to improve the efficiency of collection and delivery operation.

A navigation apparatus adapted for vehicle information and communication system (VICS) is capable of receiving information on traffic jams and traffic accidents so that route guidance based on such information is available. The capability to compute the time required before arriving at a destination is also provided. The user wanting to determine whether a delivery of goods can be completed before the requested time of delivery has to learn the requested time of delivery using the collection and delivery information service, and learn the required period of time to arrive at the destination using the navigation service. The user has to make a determination for each destination, based on the current time and the required period of time. Thereby, a heavy load is placed on the user.

### SUMMARY OF THE INVENTION

Accordingly, an object of the present invention is to provide a navigation apparatus and a recording medium in which a navigation application processing block providing navigation services and an optional application processing block communicate with each other to exchange data so that an optional service that uses the navigation service is provided, in which information obtained in a given service is used by another service without the user intervention, in which the frequency of user operations is reduced so that the load placed on the user is relieved, and in which the quality of optional services is improved.

Another and more specific object of the present invention is to provide a navigation apparatus and a recording medium in which the process of visual confirmation by a user is simplified so that the efficiency of collection and delivery operation is improved, by identifying the current position using a navigation service and determining whether a proper delivery destination is acknowledged by the user as a result of comparing the current position and the position of the delivery destination.

Still another object of the present invention is to provide a navigation apparatus and a recording medium in which the process of visual confirmation by a user is simplified so that the efficiency of collection and delivery operation is improved, by identifying a required period of time to arrive at a delivery destination using a navigation service, computing an expected time of arrival at the delivery destination based on the required period of time, and determining whether it is possible to arrive before the scheduled time of arrival.

The aforementioned objects can be achieved by a navigation apparatus for providing navigation services, comprising: a platform block provided with hardware of the navigation apparatus and basic functions for controlling the hardware; a navigation application processing unit for providing navigation services using the basic functions provided in the platform block; and an optional application processing block for providing optional services using any of the navigation services based on information acquired using the basic functions of the platform block, by communicating with the navigation application processing block.

The optional application processing block may be an application executed on a virtual platform and is independent of the platform block.

The optional application processing block may be a Java application executed on a Java virtual machine, and the navigation application processing unit may communicate with the optional application processing block in accordance with Java native interface.

The navigation application processing block may communicate with the optional application processing block using socket communication.

The aforementioned objects can also be achieved by a computable readable recording medium storing programs for controlling a computer to operate as a navigation apparatus providing navigation services, the programs allowing a computer to operate as: a platform block provided with basic functions for controlling the hardware of the navigation apparatus; a navigation application processing block for providing navigation services using the basic functions of the platform block; and an optional application processing block for providing optional services using any of the navigation services based on information acquired using the basic functions of the platform block, by communicating with the navigation application processing block.

The aforementioned objects can also be achieved by a navigation apparatus for providing navigation services, comprising: a platform block provided with hardware of the navigation apparatus and basic functions for controlling the hardware; a navigation application processing unit for providing navigation services using the basic functions provided in the platform block; an optional application processing block for providing optional services using any of the navigation services based on information acquired using the basic functions of the platform block; and an interface processing block for communicating with the optional application processing block and the navigation application processing block so as to enable any of the optional services to be executed.

The optional application processing block may be executed on a virtual platform and is independent of the platform.

The optional application processing block may be a Java application executed on a Java virtual machine.

The interface application block may be a Java application executed on a Java virtual machine.

The interface application block may be provided with one of a method for exchanging data with the optional application processing block and a member variable in which the optional application processing block reads and writes data, and one of a method for exchanging data with the navigation application processing block and a member variable in which the navigation application processing block reads and writes data.

The navigation application processing block may execute any of the navigation services in accordance with navigation control data supplied from the optional application processing block via the interface processing block and supply navigation information data including an interim result or an execution result to the optional application processing block via the interface processing block.

The interface processing block may generate, when it is determined that the navigation control data from the optional application processing block is composite navigation control data, plural navigation control data sets from the composite navigation control data and supply the plural navigation control data sets to the navigation application processing block.

The interface processing block may communicate with the optional application processing block using socket communication or Java RMI.

The interface processing block may communicate with the navigation application processing block using socket communication.

The interface processing block may acquire a remote optional application processing block from an external source using the basic functions of the platform block.

The interface processing block may acquire the remote optional application processing block from the external source only when a communication service used by the remote optional application processing block is available for use.

The interface processing block may display a menu of remote optional application processing blocks using the basic functions of the platform block, add to the menu the remote optional application processing block when the remote optional application processing block is acquired from the external source and start the acquired remote optional application processing block when selected from the menu.

The optional application processing block may supply a request for required communication services to the interface processing block, and the interface processing block may dynamically start the requested communication services upon receipt of the request.

The interface processing block may acquire a module for executing the requested communication services corresponding to the request when the module is not available.

The optional application processing block may provide collection and delivery information services using any of the navigation services, based on information acquired from a predetermined center using the basic functions of the platform block.

### BRIEF DESCRIPTION OF THE DRAWINGS

Other objects and further features of the present invention will be apparent from the following detailed description when read in conjunction with the accompanying drawings, in which:

FIG. 1 is a block diagram showing a hardware construction of a navigation apparatus according to a first embodiment;

FIG. 2 shows a hierarchical construction of the navigation apparatus according to the first embodiment;

FIG. 3 shows an example of a vehicle operation instruction supplied from a distribution center to the navigation apparatus according to the first embodiment;

FIG. 4 shows an example of a displayed menu of collection and delivery information services provided by the navigation apparatus according to the first embodiment and an example of displayed scheduled delivery route;

FIG. 5 shows an example of a displayed menu of collection and delivery information services provided by the navigation apparatus according to the first embodiment and an example of displayed entire delivery route;

FIG. 6 is a flowchart showing an operation of route search that searches for a route to a delivery destination;

FIG. 7 is a flowchart showing an operation of computing a time of arrival at the delivery destination;

FIG. 8 shows a hierarchical construction of a navigation apparatus according to a second embodiment;

FIG. 9 shows a hierarchical construction of a navigation apparatus according to a third embodiment;

FIG. 10 is a flowchart showing an operation of route search that searches for a route to the delivery destination;

FIG. 11 is a flowchart showing an operation of computing a time of arrival at the delivery destination;

FIG. 12 shows a hierarchical construction of a navigation apparatus according to a fourth embodiment of the present invention;

FIG. 13 shows a hierarchical construction of a navigation apparatus according to a fifth embodiment of the present invention;

FIG. 14 shows a hierarchical construction of a navigation apparatus according to a sixth embodiment of the present invention;

FIG. 15 is a flowchart showing an operation executed when a “entire delivery route” item is selected;

FIG. 16 shows a hierarchical construction of a navigation apparatus according to an eighth embodiment of the present invention;

FIG. 17 shows a hierarchical construction of a navigation apparatus according to a ninth embodiment of the present invention;

FIG. 18 shows a hierarchical construction of a navigation apparatus according to a tenth embodiment of the present invention;

FIG. 19 shows an example of displayed menu according to an interface module of the navigation apparatus according to the tenth embodiment;

FIG. 20 is a block diagram showing a hardware construction of a navigation apparatus according to the related art;

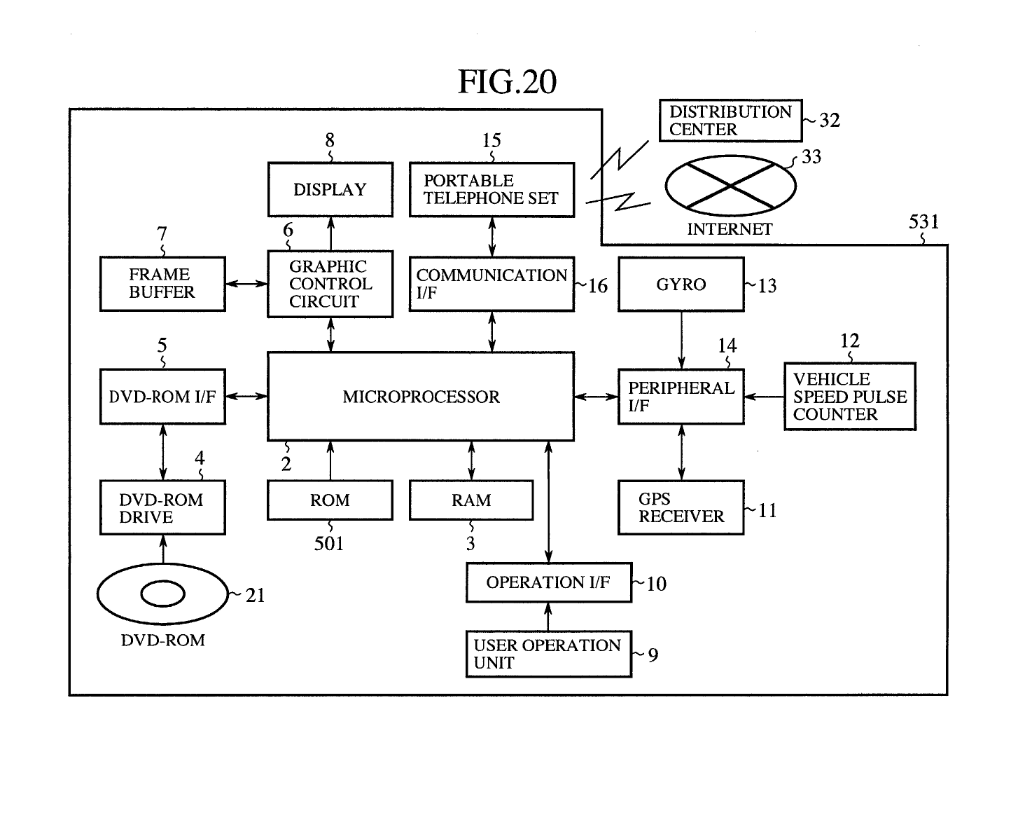

FIG. 21 shows a hierarchical construction of the navigation apparatus according to the related art;

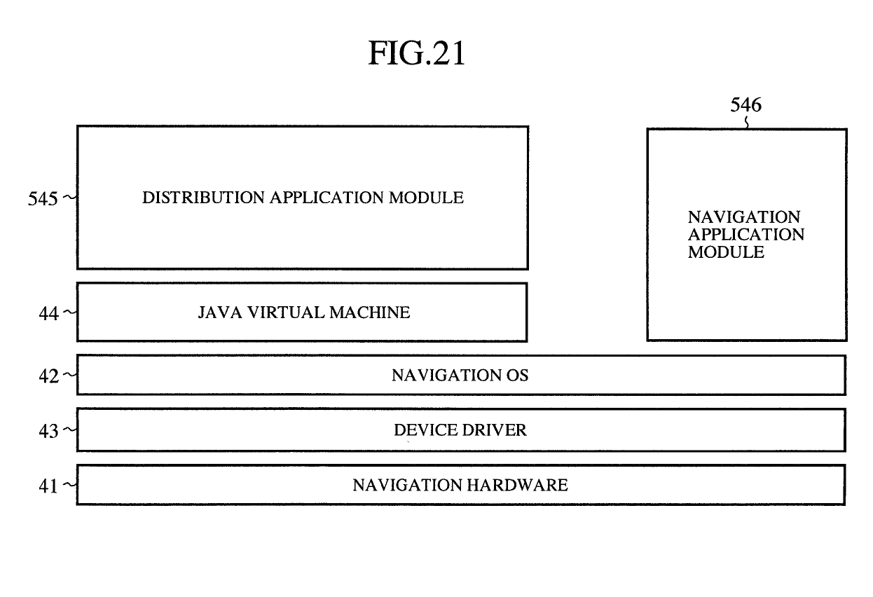

FIG. 22 is an example of a vehicle operation instruction supplied from a distribution center to the navigation apparatus according to the related art; and

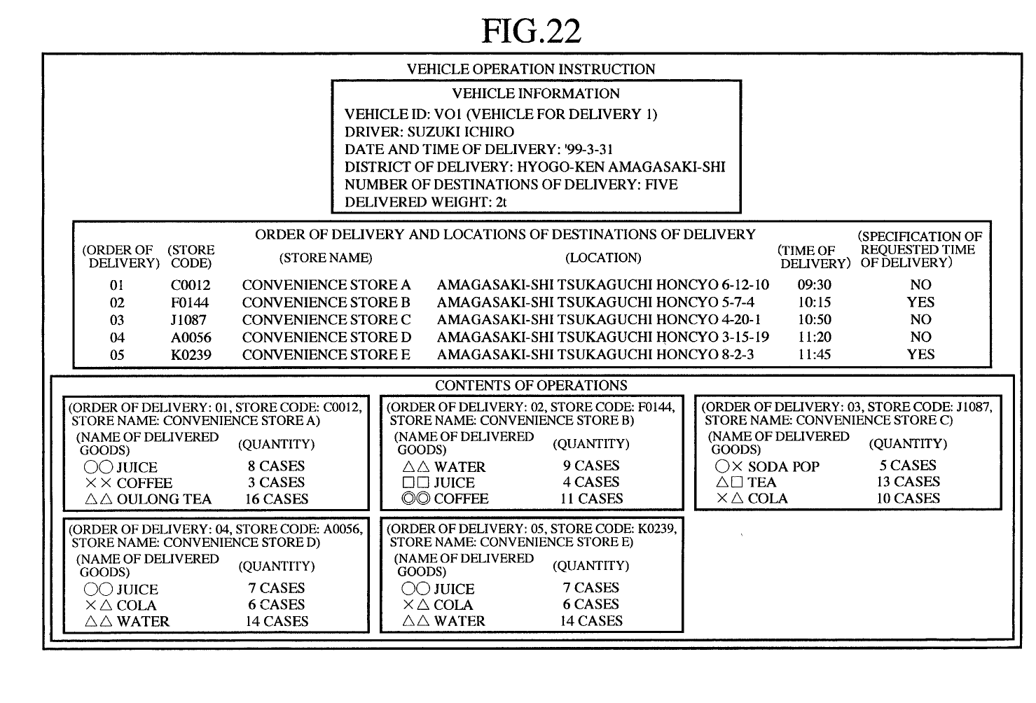

FIG. 23 shows an example of a displayed menu of collection and delivery information services provided by the navigation apparatus according to the related art.

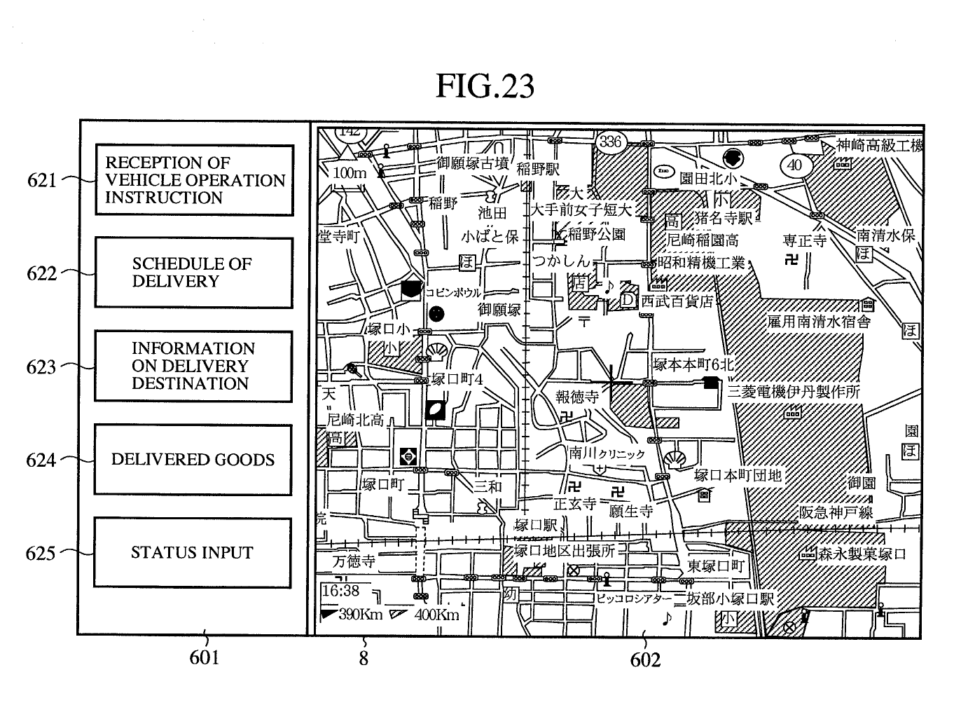

### DETAILED DESCRIPTION OF THE PREFERRED EMBODIMENTS

First Embodiment

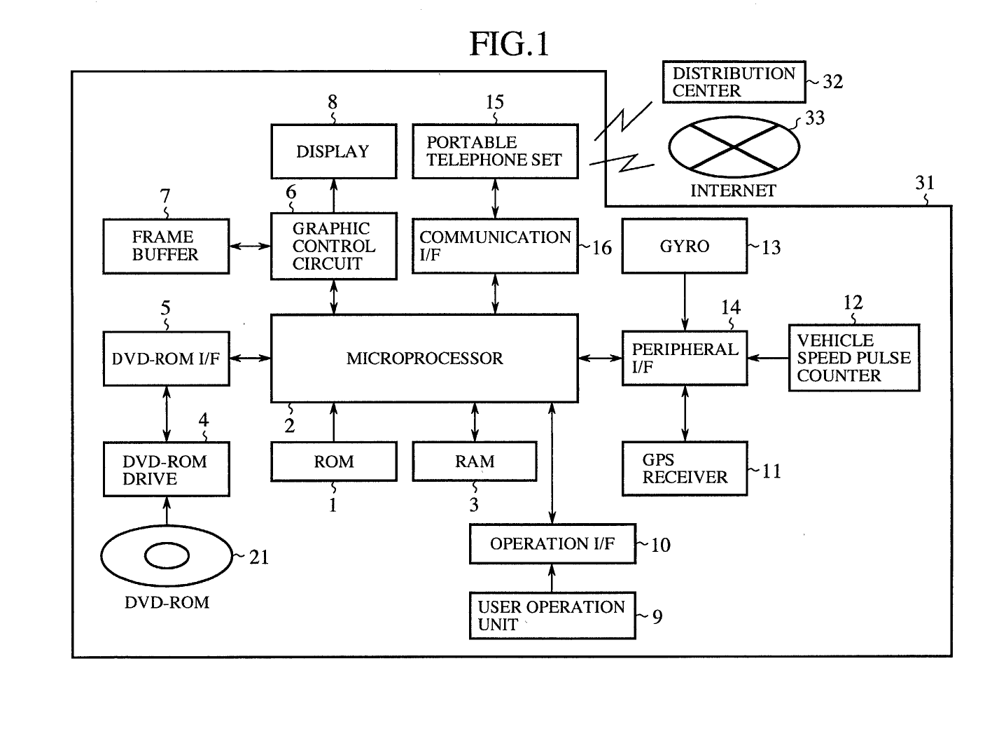

FIG. 1 is a block diagram showing a hardware construction of a navigation apparatus according to a first embodiment of the present invention. Referring to FIG. 1, a navigation apparatus according to the first embodiment includes a ROM (recording medium) 1 that stores a navigation OS, a device driver, a navigation application module, a distribution application module, Java virtual machine and the like. A microprocessor 2 executes programs including the navigation OS, the device driver, the navigation application module, the distribution application module, the Java virtual machine and the like. A RAM 3 temporarily stores programs and data while the navigation OS, the device driver, the navigation application module, the distribution application module, the Java virtual machine or the like is being executed.

A DVD-ROM drive 4 drives a DVD-ROM 21 so as to read data therefrom. A DVD-ROM interface 5 is used to exchange data between the DVD-ROM drive 4 and the microprocessor 2. A graphic control circuit 6 causes image data to be stored in a frame buffer 7 in accordance with an image processing instruction from the microprocessor 2 so as to draw an image corresponding to the image data on a display 8 such as a liquid crystal display. A user operation unit 9 is implemented by, for example a remote controller or switches. An operation interface 10 is used to exchange data between the user operation unit and the microprocessor 2.

A GPS receiver 11 receives radio waves from GPS artificial satellites. A vehicle speed pulse counter 12 is provided, for example, at a vehicle shaft and measures the speed of a vehicle. A gyro 13 detects the orientation of the vehicle. A peripheral interface 14 is used to exchange data between the GPS receiver 11, the vehicle speed pulse counter 12, the gyro 13 and the microprocessor 2.

A portable telephone set 15 connects to a distribution center 32 or the Internet 33 via a portable telephone network. A communication interface 16 controls the portable telephone set 15 to perform data communication and exchange data with the microprocessor 2.

A DVD-ROM 21 stores a map database and the like. Also provided in the navigation apparatus are: a speaker for outputting audio guidance and a driving circuit for driving the same; and a multiplex FM receiver, a radio beacon/light beacon receiver or the like for communicating with an external infrastructure.

Instead of using the ROM 1, the programs including the navigation OS, the device driver, the navigation application module, the distribution application module, the Java virtual machine may be stored in a recording medium such as a DVD-ROM so that the program may be read by a DVD-ROM drive. Alternatively, parts of the program may be stored in the ROM 1 so that the rest is stored in and read from a recording medium such as a DVD-ROM.

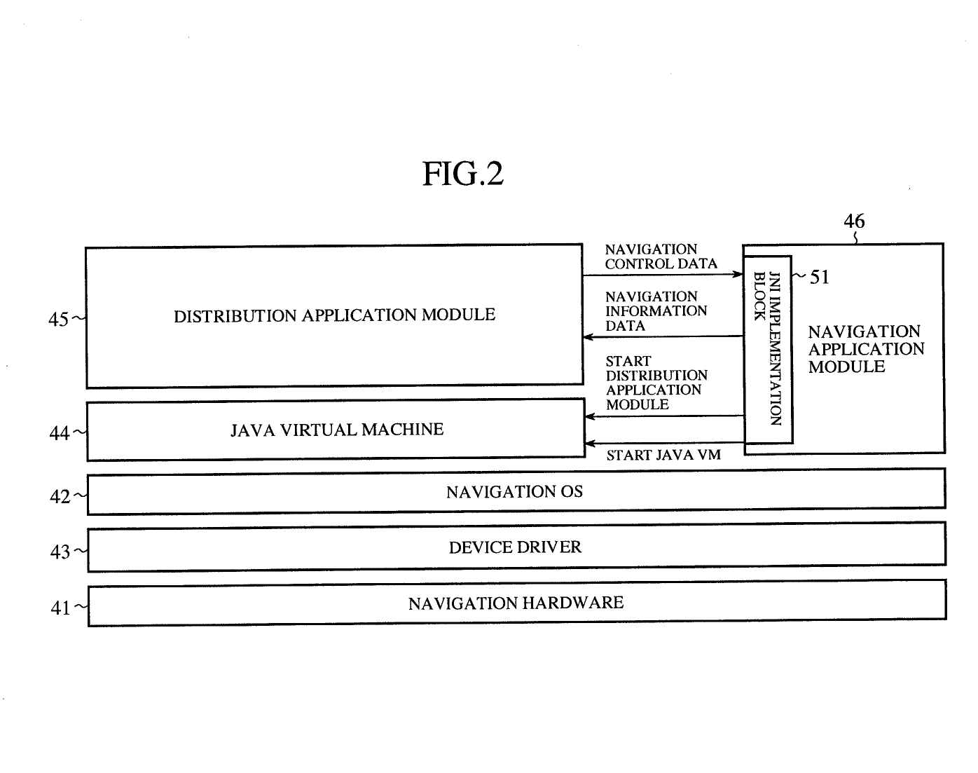

FIG. 2 shows a hierarchical construction of the navigation apparatus according to the first embodiment. Referring to FIG. 2, navigation hardware 41 comprises the microprocessor 2, the DVD-ROM drive 4, the display 8, the user operation unit 9, the GPS receiver 11, the vehicle pulse counter 12, the gyro 13 and the portable telephone set 15. A navigation OS 42 is provided with basic functions of controlling the navigation hardware 41, including memory management, process management and thread management. A device driver 43 directly controls the navigation hardware 41. The navigation hardware 41, the navigation OS 42 and the device driver 43 constitute a platform block. Windows CE from Microsoft Corporation is an embedded OS that can be used as the navigation OS 42.

The hierarchy further comprises: a Java virtual machine 44 that operates on the platform block; and a distribution application module 45 (optional application processing block) that provides collection and delivery information services (optional services) using navigation services, by communicating with the navigation application module 46, based on information acquired by using the basic functions of the platform block.

A navigation application module (navigation application processing block) 46 is a set of application programs that provide navigation services such as computation of a current position, computation of a route, guidance of a route and the like. A JNI implementation block 51 in the navigation application module 46 is provided as native codes that comply with Java Native Interface (JNI). The JNI implementation block 51 activates the Java virtual machine 44 and the distribution application module 45, a Java application, so as to read navigation control data from the distribution application module 45 and write navigation information data to the distribution application module 45. The navigation application module 46 is developed using C, C++ or the like and implemented in the form of native codes.

The navigation control data is used to designate a navigation application service and cause the designated navigation service to be executed by the navigation application module 46. The navigation information data indicates an interim result or an execution result of the navigation service executed in accordance with the navigation control data.

A description will now be given of the operation.

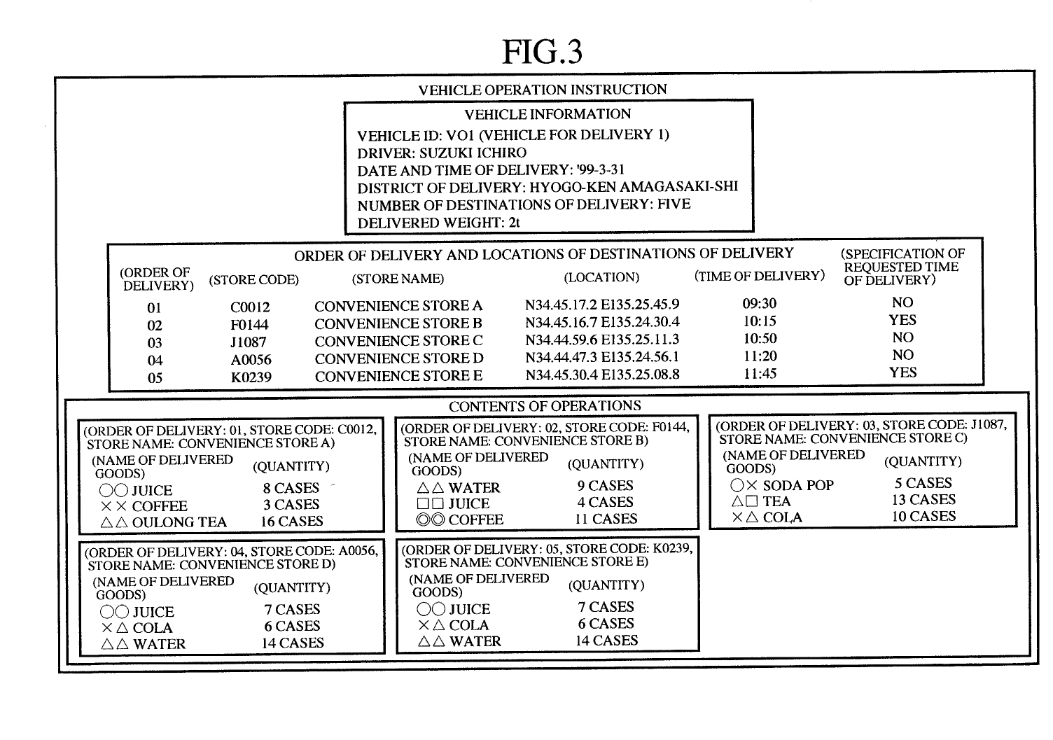

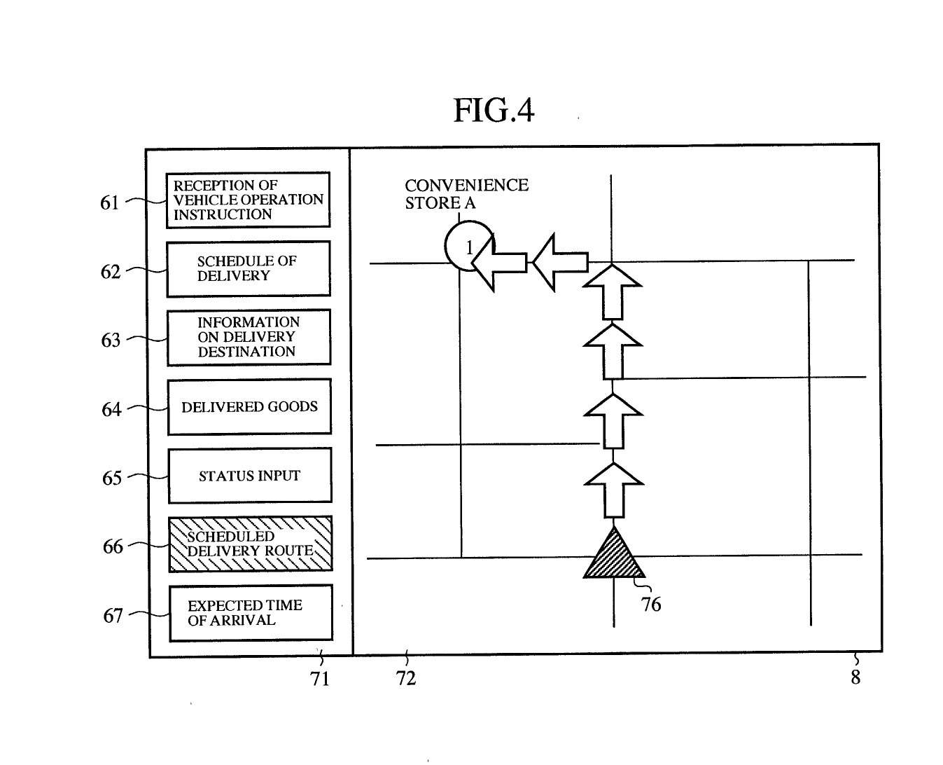

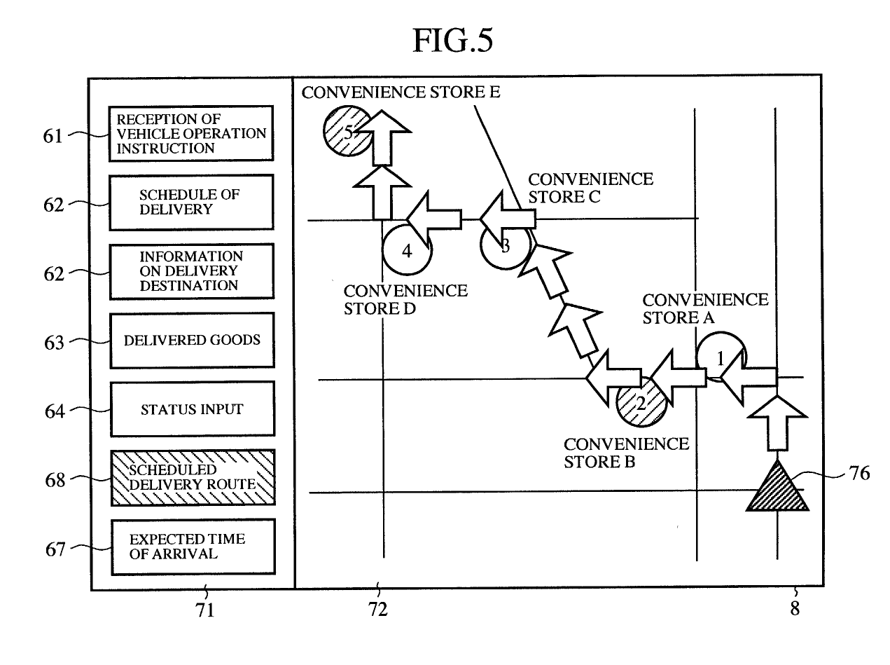

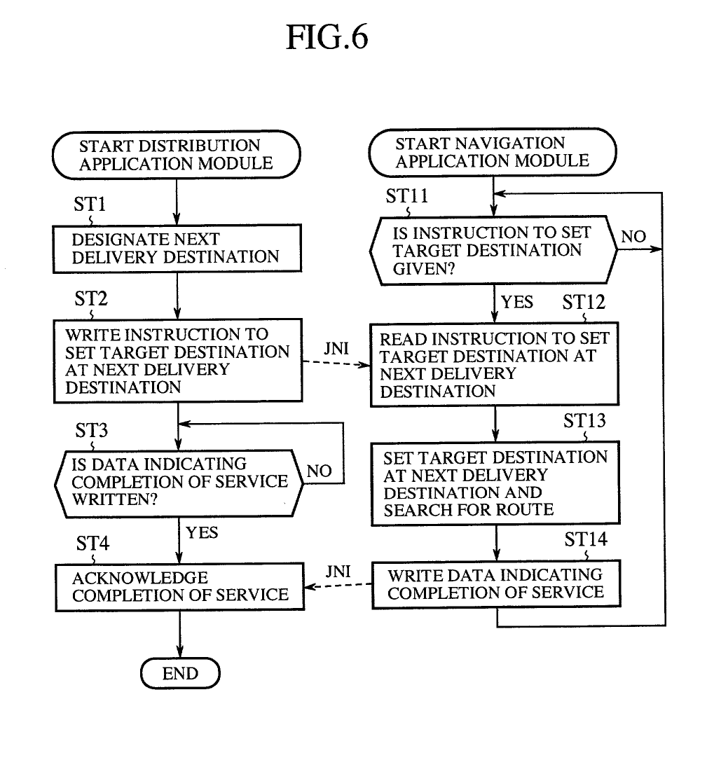

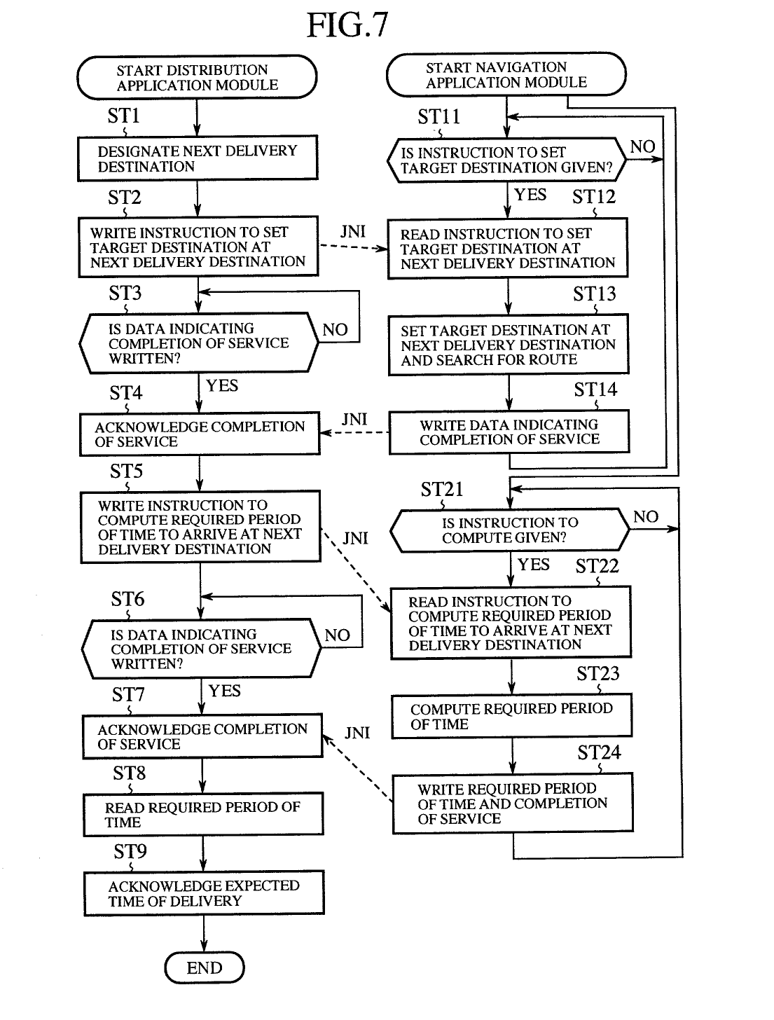

FIG. 3 shows an example of a vehicle operation instruction supplied from a distribution center 32 to the navigation apparatus according to the first embodiment. FIG. 4 shows an example of a displayed menu of collection and delivery information services provided by the navigation apparatus according to the first embodiment and an example of scheduled delivery route (route leading to a next delivery destination) displayed; FIG. 5 shows an example of displayed menu of collection and delivery information services provided by the navigation apparatus according to the first embodiment and an example of entire delivery route (route that visits an entirety of delivery destinations) displayed; FIG. 6 is a flowchart showing an operation of route search for searching for a route to a delivery destination; and FIG. 7 is a flowchart showing an operation of computing a time of arrival at the delivery destination.

The navigation OS 42, the device driver 43, the Java virtual machine 44, the distribution application module 45 and the navigation application module 46 are started by the microprocessor 2. The data acquired and generated as these programs are executed are stored in the RAM 3. The Java virtual machine 44 and the distribution application module 45 are started in compliance with JNI by the JNI implementation block 51 of the navigation module 46 started in advance. Details of JNI programming are found in Rob Gordon Java Native Interface Programming, Pierson Education. The navigation application module 46 acquires a Java environmental variable (pointer) for operating the Java virtual machine 44 and the distribution application module 45 and also acquires a pointer that holds an start address of the distribution application module 45. The Java environmental variable is acquired via a start API (application programming interface) according to JNI. The pointer that holds the start address of the distribution application module 45 is a returned value from a constructor function that starts the distribution application module 45. The navigation application module 46 exchange the navigation control data and the navigation information data with the distribution application module 45 using these pointers.

After the programs are started, the navigation application module 46 processes events (for example, user setting of a destination or an instruction to display a map) related to navigation services and generated in the navigation hardware 41 and to process the navigation control data from the distribution application module 45. For example, the navigation application module 46 provides navigation services by operating to display a guidance image on the display 8 or output audio guidance from a speaker (not shown).

The distribution application module 45 is executed on the JAVA virtual machine 44 so as to read a vehicle operation instruction as shown in FIG. 3 provided by the distribution center 32 and picked up by the portable telephone set 15, display a menu listing the collection and delivery information services on the display 8, and process events generated by the user's selection on the menu. The distribution application module 45 provides a selected collection and delivery service based on the vehicle operation instruction and using the navigation service. The user may be a driver of the vehicle or a person accompanied by the driver.

As shown in FIG. 3, the vehicle operation instruction may include vehicle information; order of delivery and locations of delivery destinations; and operations required at the destination. The vehicle information may include information related to vehicle identification, a driver and the like. The order of delivery and location of delivery may be specified as a list of store codes, store names and store locations (longitude and latitude) arranged in the order of delivery. The list also includes the time of delivery and indication of whether there is a request for the time of delivery. The operations required at the destination may be specified as a list of names of delivered goods and the quantity thereof at each of the delivery destinations. The location of delivery destination is specified as a combination of latitude and longitude. For example, convenience store A shown in FIG. 3 is located at Lat. 34°45′17.2″N. and Long. 135°25′45.9″E.

As shown in FIGS. 4 and 5, the menu of collection and delivery information services is displayed in an area 71 of the screen of the display 8. A map provided by the associated navigation service is displayed in a remaining area 72. In the area 72, route guidance provided by the collection and delivery information service and using the navigation services is displayed.

The menu of collection and delivery information services shown in FIG. 4 includes the following items: “reception of vehicle operation instruction” item 61, “schedule of delivery” item 62, “information on delivery destination” item 63, “delivered goods” item 64; “status input” item 65, “scheduled delivery route” item 66; and “expected time of arrival” item 67. The menu of collection and delivery information services shown in FIG. 5 includes the following items: “reception of vehicle operation instruction” item 61, “schedule of delivery” item 62, “information on delivery destination” item 63, “delivered goods” item 64; “status input” item 65; “entire delivery route” item 68; and “expected time of arrival” item 67. The menus of FIGS. and 4 and 5 are only given as examples and may be appropriately designed to adapt for a set of collection and delivery information services actually provided.

A cursor is moved in accordance with the user operation provided via the user operation unit 9 such as a remote controller (not shown) or operation buttons. Information related to the selected item is delivered to the distribution application module 45 so that the collection and delivery information service corresponding to the item is provided by the distribution application module 45, using, when required, the navigation service provided by the navigation application service module 46.

When using the navigation service, the distribution application module 45 writes the navigation control data corresponding to the navigation service to the member variable described above. The navigation application module 46 periodically checks the value of the member variables to determine whether the navigation control data is written. If it is determined that the navigation control data is written, the navigation application module 46 reads the navigation control data so as to execute the navigation service specified by the navigation control data.

The navigation application module 46 writes the interim result or the execution result of the navigation service to the member variable as navigation information data. The distribution application module 45 reads the navigation information data so as to determine whether to proceed to execute the next step, stand by or acknowledge termination of the navigation service, based on the value thus read.

When the “vehicle operation instruction reception” item 61 is selected by the user, the distribution application module 45 responds to the selection by controlling the communication interface 16 and the portable telephone set 15, which constitute the navigation hardware 41, via the JAVA virtual machine 44, the navigation OS 42 and the device driver 43, so as to read out the vehicle operation instruction shown in FIG. 3 from the distribution center 32. The vehicle operation instruction data is temporarily stored in the RAM 3.

When the “delivery schedule” item 62 is selected by the user, the distribution application module 45 responds to the selection by selectively reading the vehicle operation instruction stored in the RAM 3. More specifically, the distribution application module 45 reads out the order of delivery, the names of the stores at the respective destinations, the requested time of delivery and indication of whether the time of delivery is requested, for all destinations. The distribution application module 45 controls the graphic control circuit 6 via the Java virtual machine 44, the navigation OS 42 and the device driver 43 so as to display the information thus read out on the display 8.

When the “delivery destination information” item 63 is selected by the user, the distribution application module 45 responds to the selection by selectively reading the vehicle operation instruction stored in the RAM 3. More specifically, the distribution application module 45 reads out the order of delivery, the names of the stores, the locations (latitude and longitude) of the delivery destinations, for all destinations. The distribution application module 45 controls the graphic control circuit 6 via the Java virtual machine 44, the navigation OS 42 and the device driver 43 so as to display the information thus read out on the display 8.

When the “delivered goods” item 64 is selected by the user, the distribution application module 45 responds to the selection by selectively reading the vehicle operation instruction stored in the RAM 3. More specifically, the distribution application module 45 reads out the names of the stores at the respective destinations, the names of goods to delivered and the quantity thereof, for all destinations. The distribution application module 45 controls the graphic control circuit 6 via the Java virtual machine 44, the navigation OS ad the device driver 43 so as to display the information thus read out on the display 8.

When the “status input” item 65 is selected by the user, the distribution application module 45 responds to the selection by writing the navigation control data to the member variable so as to activate the navigation service for computing the current position. Upon reading the navigation control data, the navigation application module 46 computes the current position based on information from the navigation hardware 41. For example, the navigation application module 46 bases its computation on the information obtained from the GPS receiver 11. The current position thus computed is written in the member variable as the navigation information data. The distribution application module 45 reads the current position from the member variable.

The distribution application module 45 selectively reads the vehicle operation instruction stored in the RAM 3. More specifically, the distribution application module 45 reads out the order of delivery and the names of the stores at the respective destinations so as to sequentially display on the display 8 the names of the stores in the order of delivery, by controlling the graphic control circuit 6 via the Java virtual machine 44, the navigation OS 42 and the device driver 43. Buttons labeled “arrival”, “departure”, “being delivered” and “taking a rest” are also displayed on the display 8. When the “departure” button is pressed, the name of the store is updated to display the name of the store at the next delivery destination.

When the user presses one of the buttons, associated information is supplied via the user operation unit 9 to the distribution application module 45. The distribution application module 45 controls the communication interface 16 and the portable telephone set 15, which constitute the navigation hardware 41, via the Java virtual machine 44, the navigation OS 42 and the device driver 43. Accordingly, the current status corresponding to the selected button and data related to the destination are supplied to the distribution center 32. Thereby, the distribution center 32 can keep track of the current status of the vehicle and how the operation is proceeding. When the “arrival” button is pressed, the distribution application module 45 selectively reads the vehicle operation instruction stored in the RAM 3. More specifically, the distribution application module 45 reads out the location of delivery destination so as to compare the location thus read out with the current position obtained by the navigation service. A determination is then made as to whether a first distance between the delivery destination and the current position is smaller than a second distance between another delivery destination and the current position. If it is determined that the first distance is smaller than the second distance for all the other delivery destinations, the delivery destination associated with the location read out is properly selected. Otherwise, a determination is given that the delivery destination associated with the location read out is improperly selected. In this case, a delivery destination closest to the current position is selected as a current destination. Thus, any error in the selection of destination that might be caused by an erroneous user operation is corrected. The distribution center 32 can acknowledge the current status of vehicle and how the operation is proceeding, based on the data thus provided.

When the “scheduled delivery route” 66 is selected by the user, the distribution application module 45 responds to the selection in step ST1 of FIG. 6, by selectively reading the vehicle operation instruction. More specifically, the distribution application module 45 reads out the names of the stores so as to display the list of store names on the display 8. When the next delivery destination is selected by the user, associated information is supplied to the distribution application module 45.

In step ST2, The distribution application module 45 writes, in a member variable naviCommand, the navigation control data for setting a target destination at the selected delivery destination and executing a route search that guides the user to the target destination. The navigation control data may be given as, for example, a character string “setDestination, N34.45.17.2, E135.25.45.9, 1, convenience store A”. “setDestination” is a command used to set a target destination for a search and to search for a route to the target destination. A comma is used as a delimiter that separates fields. “N34.45.17.2” indicates the latitude (=Lat. 34°45′17.2″N.) of the target destination (next delivery destination) and “E135.25.45.9” indicates the longitude (=Long. 135°25′45.9″E) of the target destination (next delivery destination). “1” is an identifier that specifies an image for representing the target destination on a map. “convenience store A” is a character string displayed next to the image for representing the target destination and indicating the name of the store at the delivery destination. The navigation control data thus constructed operates to set a target destination at the next delivery destination as shown in FIG. 4.

In step ST11, the navigation application module 46 calls a predetermined method getcommand( ) provided in the distribution application module 45 in accordance with JNI at intervals of, for example, one second. The method getcommand( ) returns the value of the member variable naviCommand that holds the navigation control data to a calling entity, i.e. the navigation application module 46. The navigation application module 46 refers to the member variable naviCommand to determine whether the navigation control data is written and stands by until the navigation control data is written. If it is determined that the navigation control data for setting a target destination and requesting route search is written, control is turned to step ST12, where the navigation application module 46 operates to read out the navigation control data, call a predetermined method setprogres(progress) of the distribution application module 45, place 0, indicating that the service is being executed, in the argument progress, and write the value of the argument in the member variable commandProgress of the application service module 45. In step ST13, a target destination is set at the destination designated by the navigation control data so that route search that searches for a route to the target destination is executed.

The navigation application module 46 computes the current position and displays an image 76 representing the vehicle on the map, as shown in FIG. 4. The image specified by the identifier is displayed at the location of the target destination together with the specified character string. In the case of the navigation control data described above, an image of “type 1 circle” specified by the identifier is displayed together with the character string “convenience store A”. The result of the route search is displayed as a series of arrows indicating a route, as shown in FIG. 4. The route search is conducted using a known method such as the Dijkstra method.

When the navigation service specified by the navigation control data is completed, the navigation application module 46 calls in step ST14 the method setProgress(progress) in compliance with JNI, places a predetermined value “1”, indicating that the navigation service is completed, in the argument progress, and writes the value of the argument in the member variable commandProgress of the distribution application module 45.

After writing the navigation control data in step ST2, the distribution application module 45 proceeds to check the value of the variable commandProgress, in which the navigation information data is written, at intervals of, for example, one second. A determination is made as to whether the predetermined value “1”, indicating that the navigation service is completed, is written in the variable commandProgress. The distribution application module 45 stands by until the predetermined value “1” is written in the variable commandProgress. If it is determined that the predetermined value “1” is written in the variable commandProgress, the distribution application module 45 acknowledges in step ST4 that the service specified by the navigation control data is completed, whereupon the process is terminated.

When the “entire delivery routes” item 68 is selected by the user, the distribution application module 45 receives associated information so as to selectively read the vehicle operation instruction stored in the RAM 3. More specifically, the distribution application module 45 reads out the locations of all delivery destinations and sets a target destination at the last delivery destination. The other delivery destinations are arranged as transit points in the order of delivery. The navigation control data for setting transit points for the navigation purpose at each of the transit points thus arranged, and the navigation control data for setting a target destination and executing route guidance that guides the user to the target destination by way of the transit points are sequentially written in the variable. Subsequent operations are similar to those operations performed when the “scheduled delivery route” item 66 is selected. That is, the navigation application module 46 executes the navigation service specified by the navigation control data and writes the navigation information data. The distribution application module 45 acknowledges the completion of the navigation service.

Assuming that the vehicle operation as illustrated in FIG. 3 is requested, the navigation application module 46 displays images representing the current position, the transit points and the target destination, as shown in FIG. 5. The navigation application module 46 sets the target destination and the transit points for the navigation purpose, and displays arrows to indicate routes determined as a result of performing the route search. Since convenience store B and convenience store E are associated with requests for time of delivery, images differentiated from those of the other transit points are displayed, so as to indicate that the time of delivery is requested as well as scheduled.

When the “expected time of arrival” item 67 is selected by the user, the distribution application module 45 and the navigation application module 46, receiving associated information, performs operations similar to those performed when the “scheduled delivery route” item 66 is selected. More specifically, a route search with respect to a next delivery destination is conducted in steps ST1-ST4 and in steps ST11-ST14. Subsequently, in step ST5, the distribution application module 45 writes the navigation control data for computing a required period of time to arrive at the next delivery destination, in the member variable naviCommand.

In step ST21, the navigation application module 46 reads the value of the variable naviCommand at intervals of, for example, one second in compliance with JNI so as to determine whether the navigation control data is written. The navigation application module 46 stands by until the navigation control data is written. When the navigation application module 46 determines that the navigation control data for computing the required period of time is written, control is turned to step ST22, where the navigation application module 46 reads the navigation control data. In step ST23, the navigation application module 46 computes the required period of time to arrive at the target destination by way of the route. The method of computing the required period of time is the same as that of the ordinary navigation apparatus so that the description thereof is omitted.

When the navigation service specified by the navigation control data is completed, the navigation application module 46 writes in step ST24 a predetermined value, indicating that the navigation service is completed, in the member variable commandProgress in compliance with JNI.

After writing the navigation control data in step ST5, the distribution application module 45 proceeds to step ST6, where the distribution application module 46 checks the value of the member variable commandProgress, in which the navigation information data is written, at intervals of, for example, one second, using the method getProgress( ). A determination is made as to whether the predetermined value indicating that the navigation service is completed is written in the member variable commandProgress. The distribution application module 46 stands by until the predetermined value is written in the member variable commandProgress. When the predetermined value indicating that the navigation service is completed is written in the member variable commandProgress, the distribution application module 45 acknowledges in step ST7 that the service specified by the navigation control data s completed. In step ST8, the distribution application module 45 reads the required period of time and displays the expected time of arrival on the display by computing a sum of the current time and the required period of time. If the next delivery destination is associated with a request for time of delivery, the distribution application module 45 compares the requested time of delivery with the expected time of delivery and displays guidance indicating whether it is possible to arrive at the next destination before the requested time. The current time is acquired from a timer (not shown) or the like.

When the travelling direction, the travelling speed and the like are additionally required in the service of the distribution application module 45, the navigation control data for acquiring the necessary data is supplied to the navigation application module 46. The distribution application module 45 acquires the data as the navigation information data.

The first embodiment as described above is configured such that the navigation application module 46 that provides navigation services communicates with the delivery application service module 45 so as to exchange the navigation control data and the navigation information data. With this, the collection and delivery information service that uses the navigation service is provided. An advantage is that the frequency of user intervention is reduced so that the load placed on the user is reduced. Quality of the collection and delivery information service is also improved. Consequently, the efficiency of the collection and delivery operation is improved.

By acquiring the current position using the navigation service and accordingly determining whether the delivery destination to which the user is heading is the properly selected, by comparing the current position and the location of the delivery destination, the user intervention required for visual confirmation is simplified and the efficiency of collection and delivery operation is improved.

By acquiring the required period of time to arrive at the delivery destination, using navigation service, and determining whether it is possible to arrive at the destination before the scheduled time of delivery, the user intervention required for visual confirmation is simplified and the efficiency of collection and delivery operation is improved.

The distribution application module 45 is written in Java, a platform-independent language, and executed on the Java virtual machine 44. Therefore, by developing the distribution application module 45 on a Java virtual machine operated on a suitable platform, improvement in the efficiency of development of the module is expected.

Second Embodiment

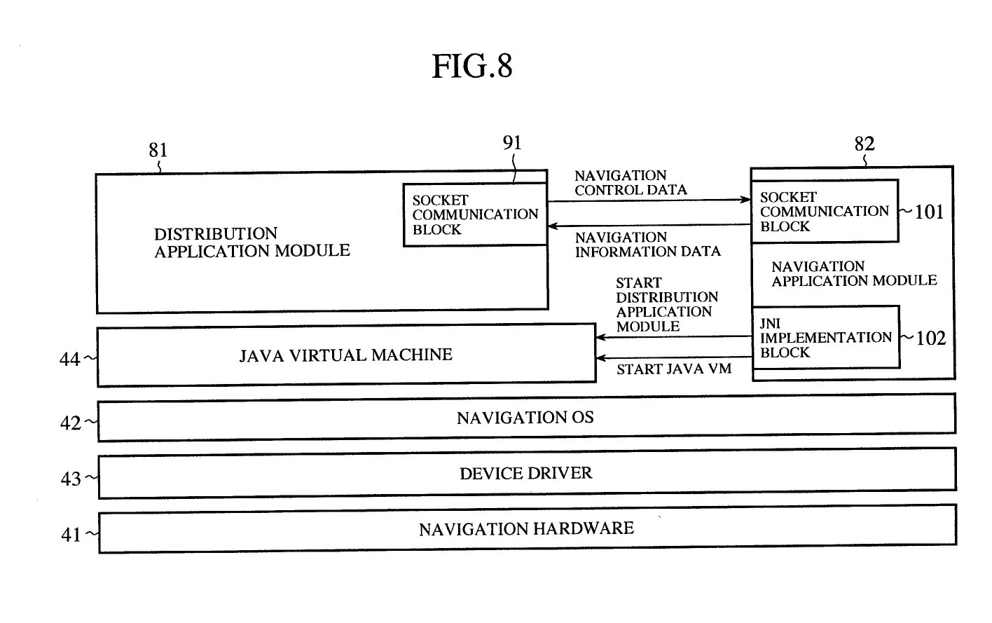

FIG. 8 is a hierarchical construction of a navigation apparatus according to a second embodiment of the present invention. Referring to FIG. 2, the navigation apparatus comprises a distribution application module (optional application processing block) 81 that provides collection and delivery information services using navigation services (optional services), by performing socket communication with a navigation application module 82, using a built-in socket communication block 91 and based on information acquired by using the basic functions of the platform block.

A navigation application module (navigation application processing block) 82 implemented as a group of application programs that provide navigation services such as computation of a current position, route search and route guidance. The navigation application module 82 includes a socket communication block 101 that communicates with the distribution application module 81 so as to exchange navigation control data and navigation information data. A JNI implementation block 102 in the navigation application module 82 is provided as native codes that comply with Java Native Interface (JNI), activates the Java virtual machine 44 and the distribution application module 81, a Java application.

The other constituting elements of FIG. 8 and the hardware construction of the navigation apparatus according to the second embodiment are substantially identical to those of the first embodiment so that the description thereof is omitted.

A description will now be given of the operation according to the second embodiment.

In the navigation apparatus (FIG. 2) according to the first embodiment, the navigation control data and the navigation information data are exchanged between the distribution application module 45 and the navigation application module 46. In the navigation apparatus (FIG. 8) according to the second embodiment, the navigation control data and the navigation information data are exchanged between the distribution application module 81 and the navigation application module 82.

When the collection and delivery information service such as the “scheduled delivery route” is selected by the user from the menu as shown in FIG. 4 or FIG. 5 so that the associated navigation control data is to be supplied to the navigation application module 82 accordingly, the socket communication block 91 communicates with the socket communication block 101 so that the navigation control data is transmitted to the navigation application module 82.

When the socket communication block 101 receives the navigation control data, the navigation application module 82 terminates the other processes so as to execute the navigation service specified by the navigation control data. Alternatively, the navigation application module 82 executes the specified navigation service after completing a process currently in execution. The navigation application module 82 provides the navigation information data, constructed of the interim result or the execution result obtained as a result of executing the navigation service, to the distribution application module 81, using socket communication between the socket communication block 101 and the socket communication block 91.

The navigation control data and the navigation information data are thus exchanged by socket communication. The other aspects of the operation according to the second embodiment are the substantially identical to the corresponding operations according to the first embodiment so that the description thereof is omitted.

As described, according to the second embodiment, the additional advantages not available in the first embodiment are available. By exchanging the navigation control data and the navigation information data by socket communication, monitoring of variables for data exchange as described in the first embodiment is not necessary. Therefore, the load placed on the navigation application module 82 is reduced.

Third Embodiment

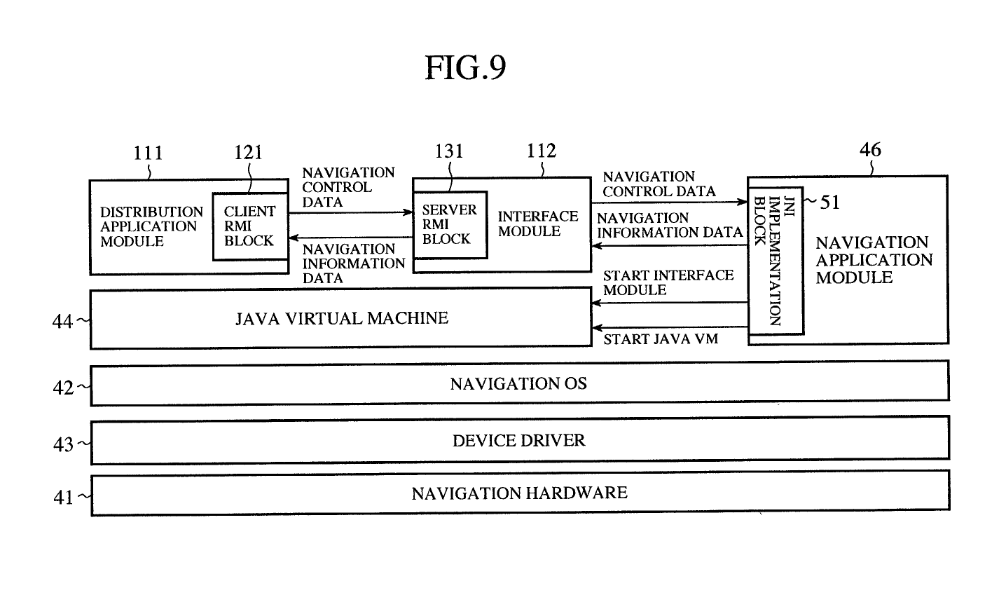

FIG. 9 shows a hierarchical construction of a navigation apparatus according to a third embodiment of the present invention. Referring to FIG. 9, the navigation apparatus includes a distribution application module (optional application processing block) 111 that provides collection and delivery information services that uses navigation services, by activating a built-in client remote method invocation (RMI) block 121 to communicate with a server RMI block 131, based on information acquired by using the basic functions of the platform block.

An interface module (interface processing block) 112, a Java application, communicates with the distribution application module 111 using Java RMI in order to perform collection and delivery information services, and also communicates with the navigation application module 46 in compliance with JNI, so as to exchange the navigation control data and the navigation information data between the distribution application module 111 and the navigation application module 46. Java RMI is known as a distributed object technology that makes member variables and methods of remote objects available as member variables and methods of local objects.

The other constituting elements of FIG. 9 and the hardware construction of the navigation apparatus according to the third embodiment are the same as the corresponding elements and construction according to the third embodiment so that the description thereof is omitted. There is a difference though in that the navigation application module 46 exchanges the navigation control data and the navigation information data with the interface module 112.

A description will now be given of the operation according to the third embodiment.

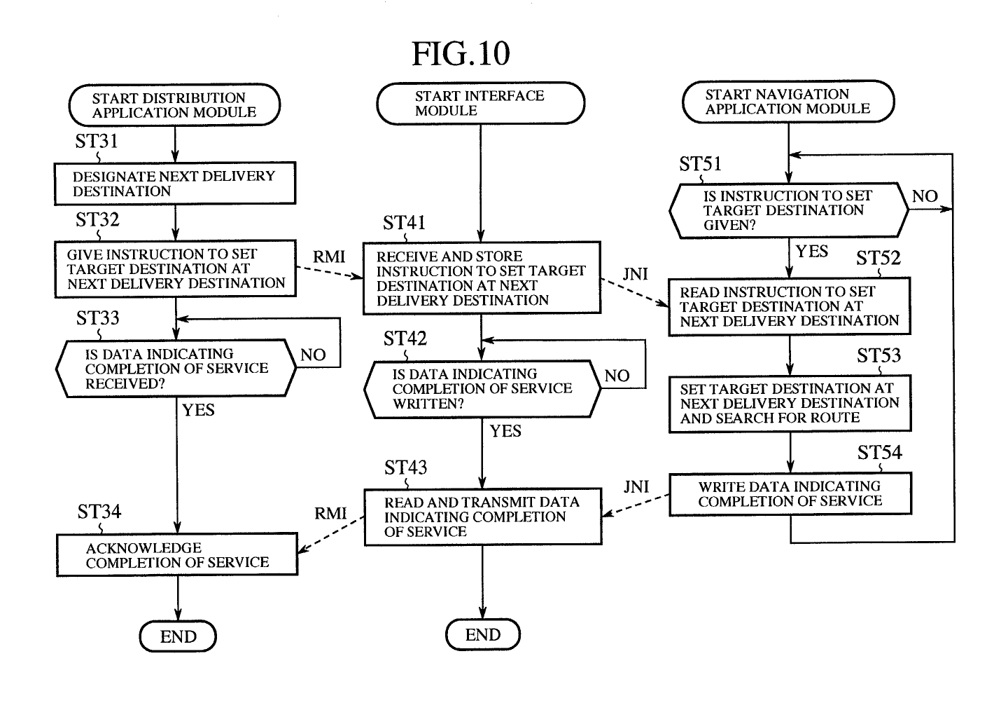

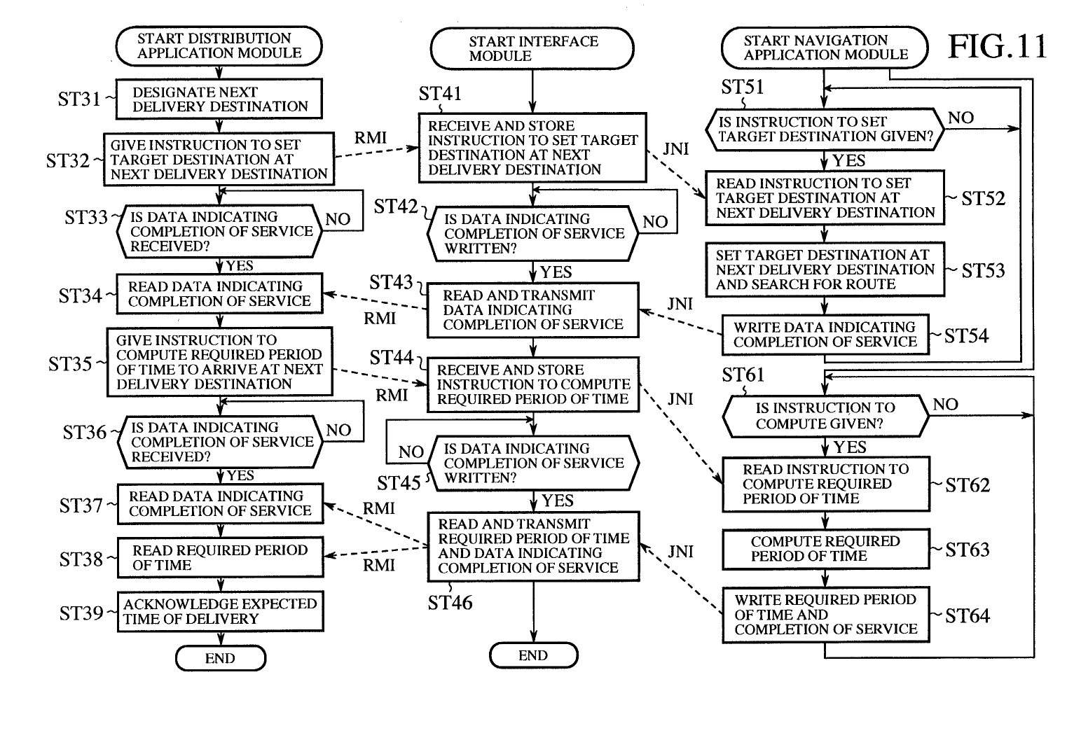

FIG. 10 is a flowchart showing an operation of route search that searches for a route to a target destination set at a delivery destination. FIG. 11 is a flowchart showing an operation of computing a time of arrival at the target destination set at the delivery destination.

The navigation apparatus according to the third embodiment is constructed such that the Java virtual machine 44 and the interface module 112 are started by the JNI implementation block 51 of the navigation application module 46 in compliance with JNI. The distribution application module 111 is started by the interface module 112. When the interface module 112 is started, the server RMI block 131 of the interface module 112 is registered in a registry server (not shown) that operates on the Java virtual machine 44. The navigation application module 46 acquires a pointer to the variable, shared with the interface module 112, in the form of a value returned from a constructor function for starting the Java virtual machine 44 and the interface module 112. The variable pointed at by the pointer is used to exchange the navigation control data and the navigation information data. The member variable described in a header file may be shared so that the navigation control data and the navigation information data are exchanged.

When the navigation service is used, the distribution application module 111 transmits the navigation control data corresponding to the navigation service to the server RMI block 131 of the interface module 112 via the client RMI block 121. The client RMI block 121 acquires a reference to the RMI block 131 from the registry server (not shown) so as to transmit the data to the server RMI block 131 based on the acquired reference. The interface module 112 receiving the navigation control data via the server RMI block writes the navigation control data in the member variable shared with the navigation application module 46. The navigation application module 46 checks the member variable at predetermined intervals so as to determine whether the navigation control data is written. When it is determined that the navigation control data is written, the navigation application module 46 reads out the navigation control data so as to execute the navigation service designated by the navigation control data.

The navigation application module 46 writes the navigation information data, constructed of the interim result or the execution result of the navigation service, in the member variable. The interface module 112 examines the value of the member variable at predetermined intervals so as to determine whether the navigation information data has been written. If it is determined that the navigation information data has been written, the navigation application module 46 reads out the navigation information data and transmits the navigation information data to the distribution application module 111 via the server RMI block 131. The distribution application module 111 receives the navigation information data via the client RMI block 121 before proceeding to the next step or acknowledging termination of the service.

The navigation control data and the navigation information data are thus exchanged via the interface module 112. The other aspects of the operation are substantially identical to those of the corresponding aspects according to the first embodiment so that the description thereof is omitted.

A description will now be given of the operation of the navigation apparatus according to the third embodiment wen the “scheduled delivery route” item 66 or the “expected time of arrival” item 67 is selected from the menu shown in FIG. 4.

When the “scheduled delivery route” item 66 is selected, the distribution application module 111 receiving associated information selectively reads the vehicle operation instruction stored in the RAM 3. More specifically, the distribution application module 111 reads out in step ST31 the names of the stores at the respective destination of delivery so that a list of the names of the stores at the respective destinations is displayed on the display 8. When the user selects a next delivery destination, associated information is supplied to the distribution application module 111.

In the subsequent step ST32, the distribution application module 111 transmits the navigation control data for setting a target destination at the next delivery destination and searching for a route to the target destination, to the interface module 112 via the client RMI block 121. The interface module 112 receives in step ST41 the navigation control data via the server RMI block 131 and writes the navigation control data in the member variable naviCommand shared with the navigation application module 46.

In step ST51, the navigation application module 46 reads in step ST51 the value of the member variable naviCommand at intervals of, for example, one second in accordance with JNI, so as to determine whether the navigation control data has been written. The navigation application module 46 stands by until the navigation control data is written. If it is determined that the navigation control data for destination setting and route search has been written, the navigation application module 46 proceeds to step ST52, where the navigation application module 46 reads the navigation control data. In a subsequent step ST53, the navigation application module 46 sets a target destination for the navigation purpose at the delivery destination designated by the navigation control data and performs an associated route search, the same steps performed in the first embodiment. For example, a guidance image as shown in FIG. 4 is consequently displayed.

When the navigation service designated by the navigation control data is completed, the navigation application module 46 writes in step ST45 a predetermined value indicating completion of the navigation service in the member variable commandProgress in accordance with JNI. The interface module 112 examines in step ST42 the value of the variable commandProgress at intervals of, for example, one second. The interface module 112 stands by until the value indicating completion of the service is written in the member variable commandProgress. When the value indicating completion of the service is written in the member variable commandProgress, control is turned to step ST43, where the interface module 112 reads out the navigation information data indicating completion of the service from the member variable commandProgress so as to transmit the navigation information data to the distribution application module 111 via the service RMI block 131.

After transmitting the navigation control data in step ST32, the distribution application module 111 examines in step ST33 at intervals of, for example, one second, whether the navigation information data indicating completion of the service is received by the client RMI block 121. The distribution application module 111 stands by until the navigation information data is received. When the navigation information data is received, the distribution application module 111 acknowledges in step ST34 that the service designated by the navigation control data is completed before terminating the process.

When the “expected time of arrival” item 67 is selected, the distribution application module 111 receiving associated information, the interface module 112 and the navigation application module 46 operate similarly as when the item 66 is selected. That is, in steps ST31-ST34, steps ST41-ST43 and steps ST51-ST54, the next destination is designated as a target destination for the navigation purpose. In step ST35, the distribution application module 111 transmits the navigation control data for computation of a required period of time to arrive at the target destination (i.e., the next destination) to the interface module 112 via the client RMI block 121. The interface module 112 receives in step ST44 the navigation control data via the server RMI block 131 so as to write the navigation control data in the member variable naviCommand shared with the navigation application module 46.

In step ST61, the navigation application module 46 reads the value of the variable naviCommand at intervals of, for example, one second in accordance with JNI. A determination is made as to whether the navigation control data is written. The navigation application module 46 stands by until the navigation control data is written. If it is determined that the navigation control data for execution of computation of the required period of time is written, control is turned to step ST62, whereupon the navigation application module 46 reads out the navigation control data. In a subsequent step ST63, the period of time required to travel to the target destination is computed.

When the navigation service designated by the navigation control data is completed, the navigation application module 46 writes in step ST64 a predetermined value, indicating that the service is completed, in the member variable commandProgress in accordance with JNI. The interface module 112 examines in step ST45 the value of the member variable commandProgress at intervals of, for example, one second. The interface module 112 stands by until the value indicating completion of the service is written. When the value indicating completion of the service is written, the interface module 112 reads out the navigation information data indicating completion of the service from the member variable commandProgress so as to transmit the navigation information data thus read out to the distribution application module 111 via the server RMI block 131.

After transmitting the navigation control data in step ST35, the distribution application module 111 examines, at intervals of, for example, one second, in step ST36 whether the navigation information data related to completion of the service and computation of the required period of time is received by the client RMI block 121. The distribution application module 111 stands by until the navigation information data is received. When the navigation information data is received, the distribution application module 111 acknowledges in step ST37 that the service designated by the navigation control data is completed. In step ST38, the distribution application module 111 reads out the computed required period of time. In step ST39, the distribution application module 111 displays on the display 8 a sum of the current time and the computed required period of time as the expected time of arrival. When a requested time of arrival is specified for the next delivery destination, the distribution application module 111 compares the requested time of arrival with the expected time of arrival and displays on the display 8 a message indicating whether it is possible to arrive at the next delivery destination before the requested time of arrival.

The other aspects of the operation are substantially identical to the corresponding aspects of the operation according to the first embodiment so that the description thereof is omitted.

Thus, according to the third embodiment, the distribution application module 11 and the navigation application module 46 are configured to exchange data via the interface module 112. An advantage added to the advantages according to the first embodiment is that, by providing an interface module, the operation of the distribution application module can be checked in a different platform while the environment is maintained. The applications can be developed by one with the knowledge of Java so that the efficiency of development is improved.

Fourth Embodiment

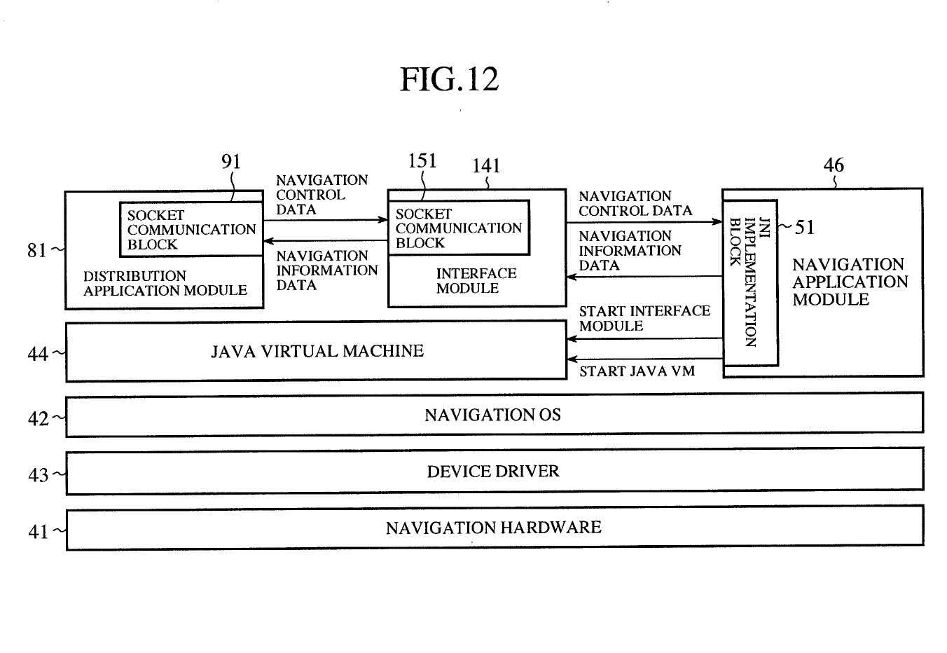

FIG. 12 shows a hierarchical construction of a navigation apparatus according to a fourth embodiment of the present invention. Referring to FIG. 12, an interface module (interface processing block) 141, a Java application, communicates with the distribution application module 81 in order to execute collection and delivery information services, using socket communication. The interface module 141 also communicates with the navigation application module 46 in accordance with JNI so that the distribution application module 81 and the navigation application module 46 exchange the navigation control data and the navigation information data. The interface module 141 includes a socket communication block 151 for socket communication with a socket communication block 91 of the distribution application module 81.

The other constituting elements of FIG. 12 and the hardware construction of the navigation apparatus according to the fourth embodiment are the same as the corresponding elements and construction according to the third embodiment so that the description thereof is omitted. An exception is that the distribution application module 81 communicates with the interface module 141 via the socket communication block 91.

A description will now be given of the operation according to the fourth embodiment. In the navigation apparatus according to the third embodiment, the navigation control data and the navigation information data are exchanged between the distribution application module 111 and the interface module 112 via Java RMI blocks. In the navigation apparatus (FIG. 12) according to the fourth embodiment, the navigation control data and the navigation information data are exchanged between the distribution application module 81 and the interface module 141 using socket communication.

Upon a user selection is given of one of the collection and delivery information services, such as the “scheduled delivery route” item, from the menu as shown in FIGS. 4 and 5, the distribution application module 81 transmits the navigation control data to the interface module 141 using socket communication between the socket communication block 91 and the socket communication block 151.

The interface module 141 transmits the navigation information data read out from the member variable to the distribution application module 81 using the socket communication between the socket communication between the socket communication block 151 and the socket communication block 91.

Thus, the navigation control data and the navigation information data are exchanged between the distribution application module 81 and the interface module 141 using socket communication. The other aspects according to the fourth embodiment are substantially identical to the corresponding aspects according to the third embodiment so that the description thereof is omitted.

Thus, according to the fourth embodiment, socket communication instead of Java RMI is used to exchange the navigation control data and the navigation information data. Therefore, similar advantages as are provided by the third embodiment are provided.

Fifth Embodiment

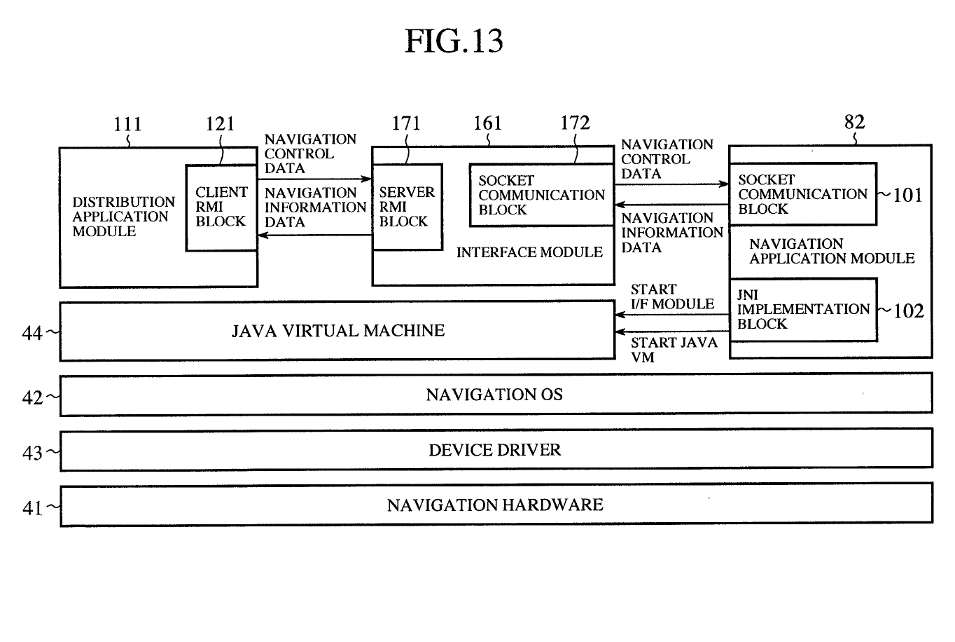

FIG. 13 shows a hierarchical construction of a navigation apparatus according to a fifth embodiment of the present invention. Referring to FIG. 13, an interface module (interface processing block) 161, a Java application, communicates with the distribution application module 111 in accordance with Java RMI in order to execute collection and delivery information services. The interface module 161 also communicates with the navigation application module 82 using socket communication so that the distribution application module 111 and the navigation application module 82 exchange the navigation control data and the navigation information data. The interface module 161 includes a server RMI block 171 for performing Java RMI data communication with the client RMI block 121 of the distribution application module 111. The interface module 161 also includes a socket communication block 172 for performing socket communication with the socket communication block 101 of the navigation application module 82 to exchange data.

The other constituting elements of FIG. 13 and the hardware construction of the navigation apparatus according to the fifth embodiment are the same as the corresponding elements and construction according to the fourth embodiment so that the description thereof is omitted. An exception is that the navigation application module 82 communicates with the interface module 161 via the socket communication block 101.

A description will now be given of the operation according to the fifth embodiment. In the navigation apparatus according to the fourth embodiment (FIG. 12), the navigation control data and the navigation information data are exchanged between the interface module 141 and the navigation application module 46 in accordance with JNI. In the navigation apparatus (FIG. 13) according to the fifth embodiment, the navigation control data and the navigation information data are exchanged between the interface module 161 and the navigation application module 82 using socket communication.

The interface module 161 transmits the navigation information data to the navigation application module 82 using socket communication between the socket communication block 171 and the socket communication block 101. The navigation application module 82 receives the navigation control data via the socket communication block 101 so as to execute the navigation service designated by the navigation control data.

The navigation application module 82 transmits the navigation application information data to the interface module 161 using socket communication between the socket communication block 101 and the socket communication block 172.

Thus, the navigation control data and the navigation information data are exchanged between the interface module 161 and the navigation application module 82 using socket communication. The other aspects according to the fifth embodiment are substantially identical to the corresponding aspects according to the fourth embodiment so that the description thereof is omitted.

Thus, according to the fifth embodiment, socket communication is used to exchange the navigation control data and the navigation information data between the interface module 161 and the navigation application module 82. In addition to the advantages provided by the third embodiment, the fifth embodiment offers an added advantage in that monitoring of a value of a variable as described in the first embodiment is not necessary for exchange of data so that the load placed on the navigation application module 82 is reduced.

Sixth Embodiment

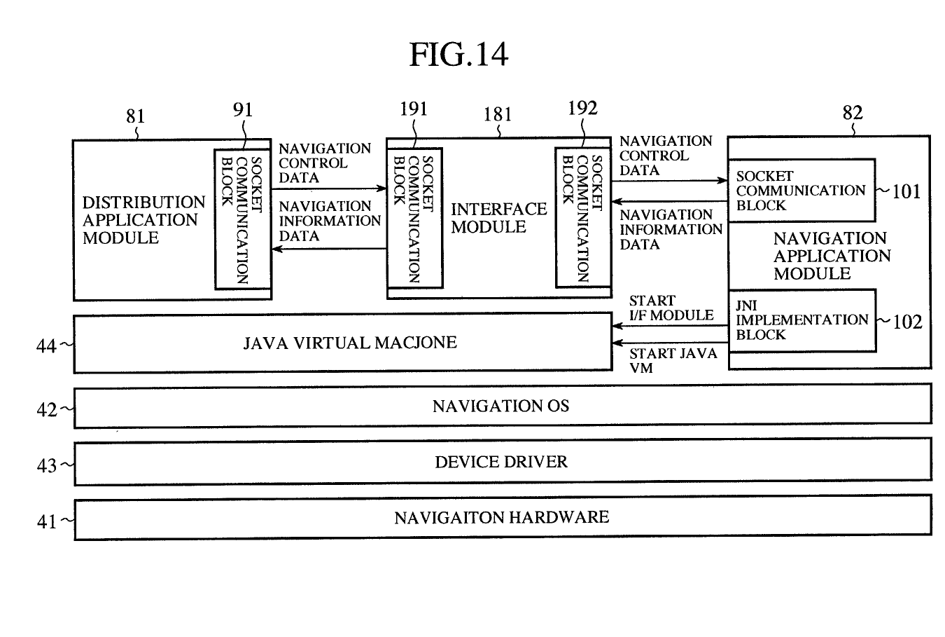

FIG. 14 shows a hierarchical construction of a navigation apparatus according to a sixth embodiment of the present invention. Referring to FIG. 14, an interface module (interface processing block) 181, a Java application, communicates with the distribution application module 81 using socket communication in order to execute collection and delivery information services. The interface module 181 also communicates with the navigation application module 82 using socket communication so that the distribution application module 81 and the navigation application module 82 exchange the navigation control data and the navigation information data. The interface module 181 includes a socket communication block 191 for performing socket communication with the socket communication block 91 of the distribution application module 81 to exchange data. The interface module 181 also includes a socket communication block 192 for performing socket communication with the socket communication block 101 of the navigation application module 82 to exchange data.

The other constituting elements of FIG. 14 and the hardware construction of the navigation apparatus according to the sixth embodiment are the same as the corresponding elements and construction according to the second embodiment so that the description thereof is omitted. An exception is that the distribution application module 81 communicates with the navigation application module 82 via the interface module 181.

A description will now be given of the operation according to the fifth embodiment. In the navigation apparatus according to the sixth embodiment, the JNI implementation block 102 of the navigation application module 82 starts the Java virtual machine 44 and the interface module 181 in accordance with JNI. The interface module 181 starts the distribution application module 81.

The distribution application module 81 transmits the navigation control data to the interface module 181 using socket communication between the socket communication block 91 and the socket communication block 191. Upon receiving the navigation control data via the socket communication block 191, the interface module 181 transmits the navigation control data to the navigation application module 82 via the socket communication block 192. The navigation application module 82 receives the navigation control data via the socket communication block 101 so as to execute the service designated by the navigation control data.

The navigation application module 82 transmits the navigation information data to the interface module 181 using socket communication between the socket communication block 101 and the socket communication block 192. Upon receipt of the navigation information data, the interface module 181 transmits the navigation information data to the distribution application module 81 using socket communication between the socket communication block 191 and the socket communication block 91.

Thus, the navigation control data and the navigation information data are exchanged between the distribution application module 81 and the navigation application module 82 via the interface module 181 using socket communication. The other aspects of the operation according to the sixth embodiment are substantially identical to the corresponding aspects according to the second embodiment so that the description thereof is omitted.

Thus, according to the sixth embodiment, socket communication instead of Java RMI (the fifth embodiment) is used for exchange of the navigation control data and the navigation information data so that an advantage substantially identical to that of the fifth embodiment is available.

Seventh Embodiment

In a navigation apparatus according to a seventh embodiment of the present invention, the navigation control data transmitted from the distribution application 81 or the distribution application 111 to the navigation application module 46 or the navigation application module 82 is composite data including a plurality of instructions. The interface module 112, the interface module 141, the interface module 161 or the interface module 181 generates plural navigation control data sets from the composite navigation control data so as to supply the generated data to the navigation application module 46 or the navigation application module 82.

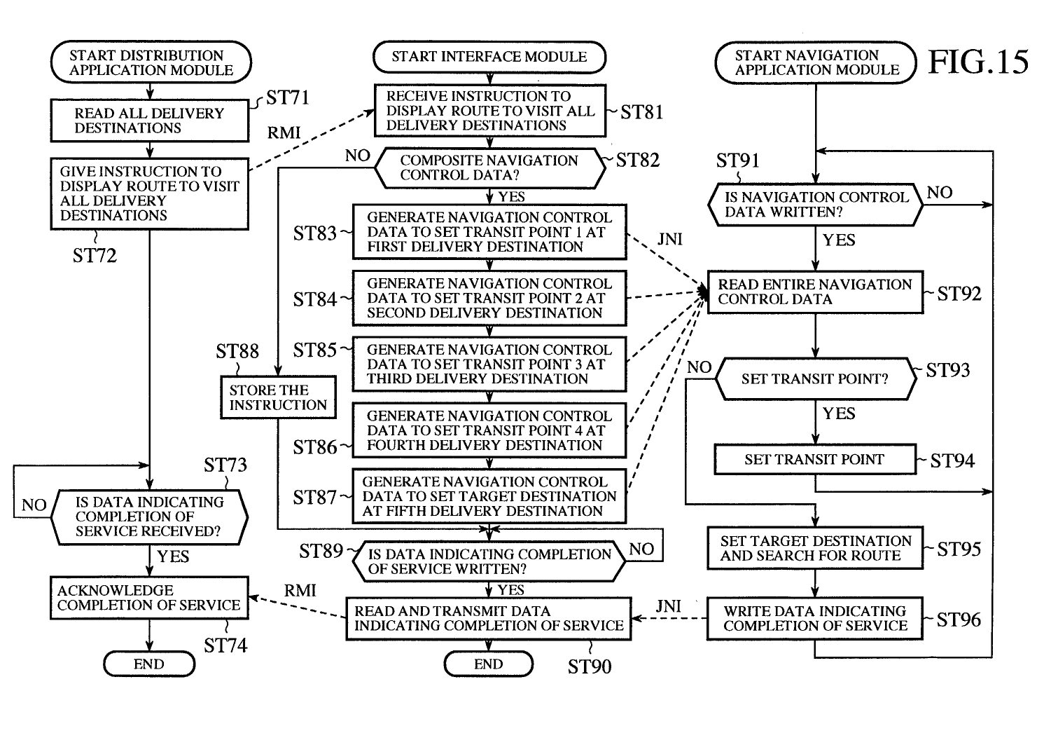

A description will now be given of the operation when the “entire delivery route” item 68 is selected from the menu. FIG. 15 is a flowchart showing the associated operation.

When the “entire delivery route” item 68 is selected by the user, the distribution application module 81 or the distribution application module 111 receiving associated information selectively reads the vehicle operation instruction stored in the RAM 3. More specifically, the distribution application module 81 or the distribution application module 111 reads out the locations of all destination of delivery. In step ST72, the distribution application module 81 or the distribution application module 111 generates composite navigation control data so as to include a predetermined instruction indicating that the data is composite, a list of locations of the destination of delivery, a list of identifiers specifying images on a map representing the respective destinations and a list of character strings displayed in associated with the respective images representing the respective destinations. The resultant composite navigation control data is supplied to the interface module 112, the interface module 141, the interface module 161 or the interface module 181.

In step ST81, the interface module 112, the interface module 141, the interface module 161 or the interface module 181 receives the composite navigation control data for display of the entire delivery routes. In step ST82, a determination is made as to whether the instruction section indicates that the transmitted data is composite navigation control data. If it is determined that the instruction section indicates that the transmitted data is composite navigation control data, the interface module examines the list of locations, the list of identifiers of the images and the list of character strings, so as to construct as many navigation control data sets as the number of destination of delivery. Each navigation control data set being comprises: an instruction for setting of transit points, or an instruction for setting a target destination and searching for a route; a location of delivery destination, an identifier and a character string. In the example of FIG. 15, it is assumed that the vehicle operation instruction, indicating a total of five destination of delivery, shown in FIG. 3 is processed. In steps ST83-ST87, a total of four navigation control data sets in which the first through fourth destinations of delivery are set as first through fourth transit points, respectively, are generated. The navigation control data in which the fifth delivery destination is designated as the target destination is also generated.

If it is determined in step ST82 that the instruction section does not indicate that the composite data is not received, control is turned to step ST88, where the interface module 112, the interface module 141, the interface module 161 or the interface module 181 supplies the received navigation control data to the navigation application module 46 or the navigation application module 82 without processing the data.

In step ST91, the navigation application module 46 or the navigation application module 82 stands by until the navigation control data is received. When the navigation control data is received, the navigation application module reads the received navigation control data in step ST92. In step ST93, a determination is made as to whether the instruction in the navigation control data is for setting a transit point. If it is determined that the instruction in the navigation control data is for setting a transit point, control is turned to step ST94, where the navigation application module 46 or the navigation application module 82 executes the navigation service by setting the transit point. When it is determined that the instruction in the navigation control data is not for setting a transit point, that is, when the instruction is for setting a target destination and searching for a route, control is turned to step ST95, where the navigation application module 46 or the navigation application module 82 executes the navigation service by setting a target destination and searching for a route. For example, a guidance image as shown in FIG. 5 is displayed on a map. In step ST96, the navigation application module 46 or the navigation application module 82 supplies the navigation information data, indicating completion of the service, to the interface module 112, the interface module 141, the interface module 161 or the interface module 181.

In step ST89, the interface module 112, the interface module 141, the interface module 161 or the interface module 181 stands by until the navigation information data indicating completion of the service is supplied. When the navigation information service indicating completion of the service is supplied, control is turned to step ST90, where the navigation information data is supplied to the distribution application module 45, the distribution application module 81 or the distribution application module 111.

In step ST73, the distribution application module 81 or the distribution application module 111 stands by until the navigation information data indicating completion of the service is supplied. When the navigation information data indicating completion of the service is supplied, control is turned to step ST74, where the distribution application module acknowledges completion of the service and terminates the process.

Thus, when the control data from the distribution application module 81 or the distribution application module 111 is composite control data, plural composite control data sets are generated from the composite control data. The plural composite control data sets are supplied to the navigation application module 46 or the navigation application module 82.

As described above, according to the seventh embodiment, the distribution application module 81 or the distribution application module 111 uses the composite navigation control data in which a plurality of instructions to the navigation application module 46 or the navigation application 82 are included. The interface module 112, the interface module 141, the interface module 161 or the interface module 181 generates plural navigation control data sets from the composite navigation control data so as to sequentially supply the navigation control data sets thus generated to the navigation application module 46 or the navigation application module 82. Accordingly, the frequency of transmissions of the navigation control data between the distribution application module 81 or the distribution application module 111 and the interface module 112, the interface module 141, the interface module 161 or the interface module 181 is reduced so that the processing time is shortened.

Eighth Embodiment

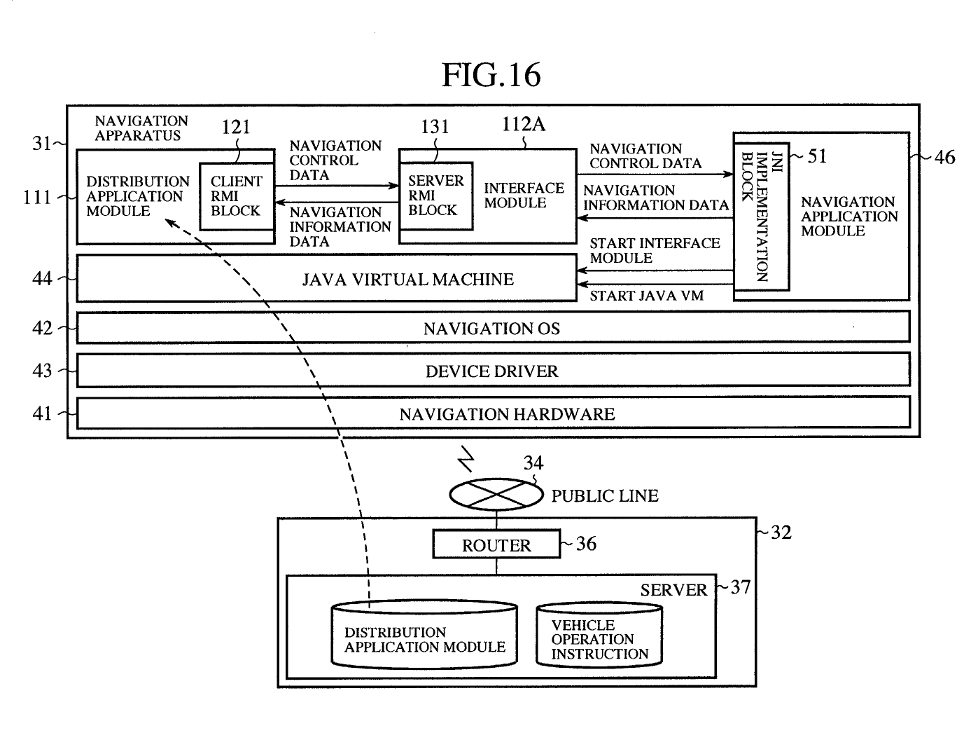

FIG. 16 shows a hierarchical construction of a navigation apparatus according to an eight embodiment of the present invention. Referring to FIG. 16, an interface module (interface processing block) 112A operates similarly as the interface module 112 of the third embodiment. The interface module 112A further controls the communication interface 16 and the portable telephone set 15 via the Java virtual machine 44, the navigation OS 42 and the device driver 43, so as to connect to a server (external device) 37 coupled to the distribution center 32 via a public line 34 such as a portable telephone line and via a router 36 coupled to the distribution center 32. The interface module 112A downloads the distribution application module 111.

The other constituting elements of FIG. 16 and the hardware construction of the navigation apparatus according to the eighth embodiment are substantially identical to the corresponding elements and construction of the third embodiment so that the description thereof is omitted. The ROM 1 herein that stores programs may be implemented by an electrically erasable and programmable ROM (EEPROM) in which the memory contents is electrically rewritable using the microprocessor 2.

A description will now be given of the operation according to the eighth embodiment.

The interface module 112A refers to date and time of creation of the distribution application module 11 stored in the ROM 1 before starting the distribution application module 111. The interface module 112A also refers to date and time of creation of the distribution application module stored in the server 37, by controlling the communication interface 16 and the portable telephone set 15 via the Java virtual machine 44, the navigation OS 42 and the device driver 43, so as to connect to the server 37 via the public line 34 and via the router 36 coupled to the distribution center 32.

If the date and time of creation of the distribution application module stored in the server 37 is more up to date than the time of creation of the distribution application module 111 stored in the ROM 1, the interface module controls the communication interface 16 and the portable telephone set 15 via the Java virtual machine 44, the navigation OS 42 and the device driver 43, so as to connect to the server 37 via the public line 34 and the router 36 coupled to the distribution center 32. Thereby, the interface module 112A downloads the distribution application module to update the distribution application module stored in the ROM 1.

When the ROM 1 does not store the distribution application module in an initial state, the interface module 112A also downloads the distribution application module.

The interface module 112A downloads the distribution application module from the server 37 only when the communication service used by the distribution application module is available for use.

The other aspects of the operation are substantially identical to the corresponding aspects according to the third embodiment so that the description thereof is omitted.

As described, according to the eighth embodiment, the interface module 112A is configured to download the distribution application module 111 from the server 37 coupled to the distribution center 32 as the occasion demands. With this construction, the efficiency of collection and delivery operation is improved since it is not necessary to install or upgrade the distribution application module individually in each vehicle for collection and delivery operation.

By configuring the interface module 112A to download the distribution application module from the server 37 only when the communication service used by the distribution application module is available for use, the distribution application module for which the interface module 112A is not adapted is prevented from being downloaded. Thereby, the apparatus is prevented from malfunction such as an abnormal operation.

Ninth Embodiment

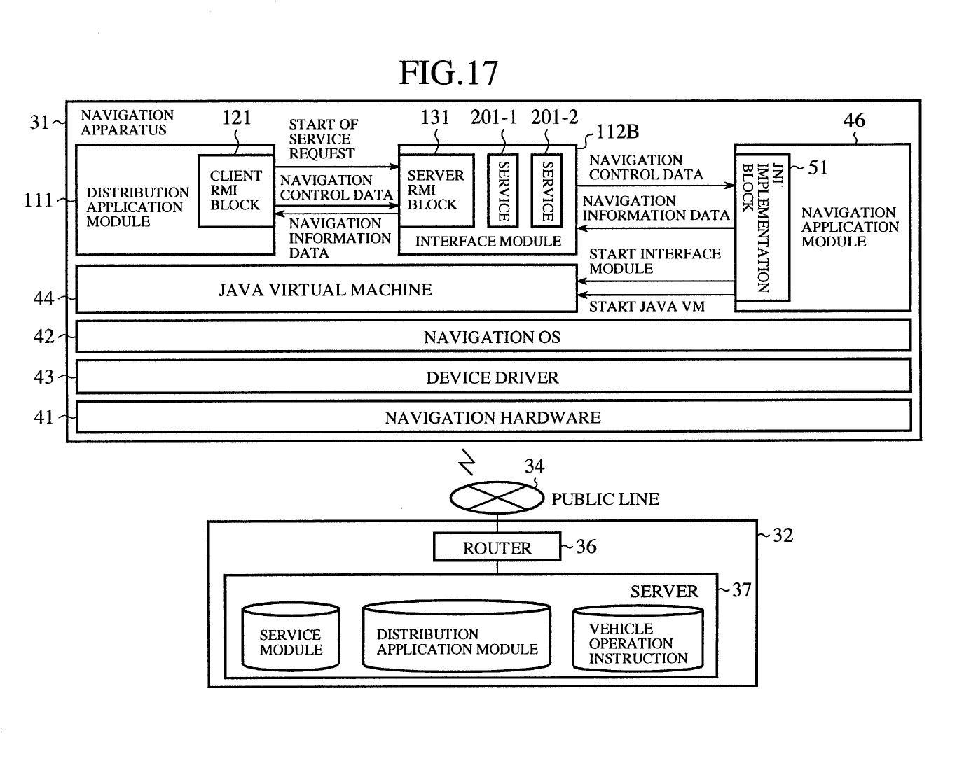

FIG. 17 shows a hierarchical construction of a navigation apparatus according to a ninth embodiment of the present invention. An interface module 112B (interface processing block) operates similarly as the interface module 112 of the third embodiment. Upon receipt of a start of service request from the distribution application module 111, the interface module 112B starts a service module 201-i for executing the communication service corresponding to the start of service request.

The other constituting elements of FIG. 17 and the hardware construction of the navigation apparatus according to the ninth embodiment are substantially identical to the corresponding elements and construction according to the third embodiment so that the description thereof is omitted. The distribution application module 111 herein provides a start of service request associated with the requested communication service to the interface module 112B, before starting to exchange the navigation control data and the navigation information data. The ROM 1 herein that stores programs may be implemented by an electrically erasable and programmable ROM (EEPROM) in which the memory contents is electrically rewritable using the microprocessor 2.

A description will now be given of the operation according to the ninth embodiment.

The distribution application module 111 provides a start of service request associated with the requested communication to the interface module before exchanging the navigation control data and the navigation information data.

Upon receipt of the start of service request from the distribution application module 111, the interface module 112B determines whether the service module 201-i, a class described in Java, for executing the communication service corresponding to the start of service request is stored in the ROM 1. When it is stored, the interface module 112B reads the service module 201-i so as to start the module. When the module is not stored in the ROM 1, the interface module 112B controls the communication interface 16 and the portable telephone set 15 via the Java virtual machine 44, the navigation OS 42 and the device driver 43, so as to connect to the server 37 coupled to the distribution center 32 via the public line 34 and via the router 36 coupled to the distribution center 32. The interface module 112B proceed to download the service module corresponding to the start of service request, store the module in the ROM 1 and starts the downloaded module. FIG. 17 shows a total of two service modules 201-1 and 202-2. However, as may modules as demanded may be provided. The communication service provided by the module may be generation of plural navigation control data sets from the composite navigation control data and services executed individually in relation to various collection and delivery information services.

The other aspects of the ninth embodiment are substantially identical to the corresponding aspects according to the third embodiment so that the description thereof is omitted.

As described, according to the ninth embodiment, the distribution application module 111 supplies the request for necessary communication services to the interface module 112B. The interface module 112B dynamically responds to the request by starting the requested communication service when available. With this construction, a memory size required for the operation is successfully reduced.

When the interface module 112B is not provided with the service module corresponding to the request, the interface module 112B acquires the service module from the server 37. Accordingly, it is not necessary to provide the interface module 112B with the entire set of service modules so that the memory size required for the operation is reduced.

Tenth Embodiment

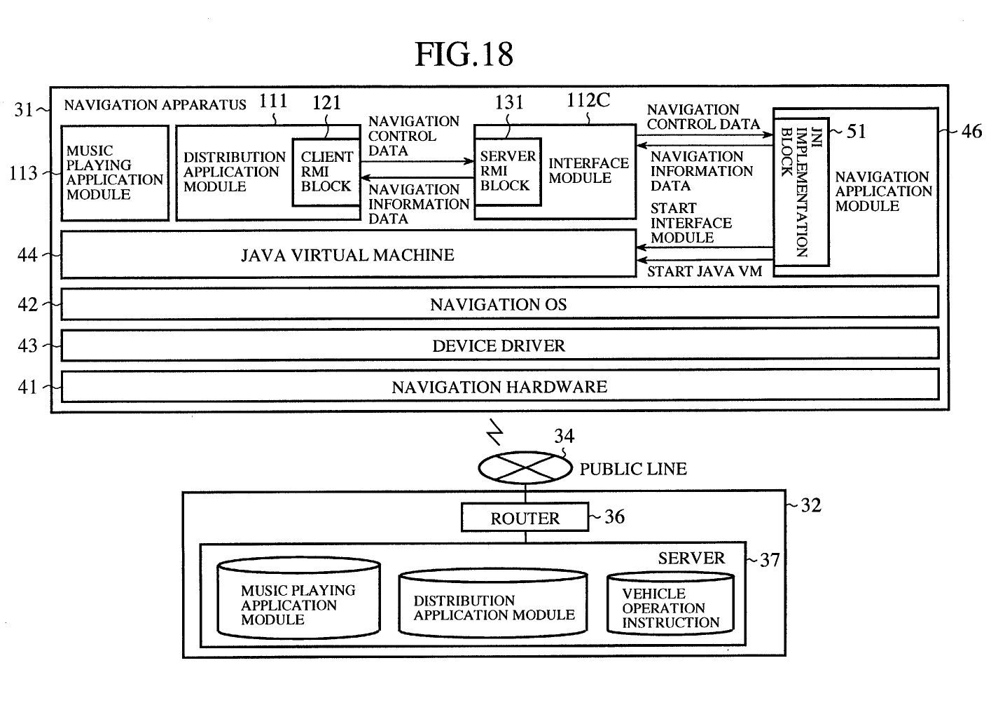

FIG. 18 shows a hierarchical construction of a navigation apparatus according to a tenth embodiment of the present invention. Referring to FIG. 18, an interface module (interface processing block) 112C operates similarly as the interface module 112 according to the third embodiment. The interface module 112C displays on the display 8 a menu of external application modules (additional application processing blocks) stored in the server 37 coupled to the distribution center 32. Further, the interface module 112C downloads the external application module selected by the user from the server 37 coupled to the distribution center 32.

A music playback application module 113, a Java application, is used to download music data from, for example, the Internet 33, play the downloaded data by outputting the music from a speaker (not shown).

The other constituting elements of FIG. 18 and the hardware construction of the navigation apparatus according to the tenth embodiment are the same as the corresponding elements and construction according to the third embodiment so that the description thereof is omitted.

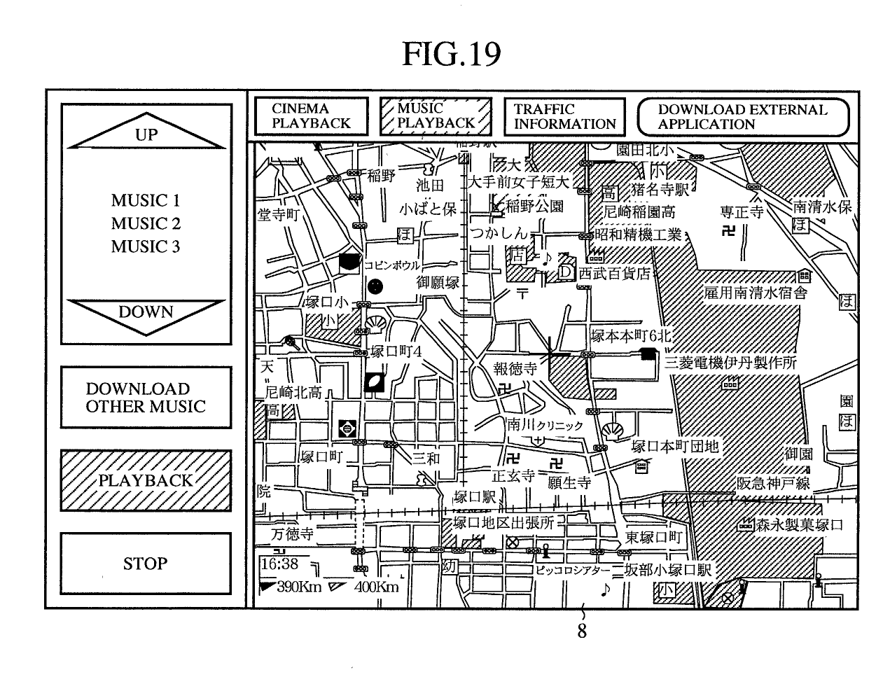

A description will now be given of the operation. FIG. 19 is an example of menu displayed by the interface module 112C of the navigation apparatus according to the tenth embodiment.

When started, the interface module 112C starts providing the communication service as performed by the interface module 112 according to the third embodiment. Moreover, the interface module 112C displays a menu as shown in FIG. 19, in which a button for downloading external applications is displayed at top right corner of the screen.

When the “download external application” button is pressed by the user, associated information is provided to the interface module 112C so that the interface module 112C controls the communication interface 16 and the portable telephone set 15 via the Java virtual machine 44, the navigation OS 42 and the device driver 43, so as to connect to the server 37 coupled to the distribution center 32 via the public line 34 and via the router 36 coupled to the distribution center 32. The interface module 112C proceed to download the external application stored in the server 37 (in this case, the music playback application module 113). The interface module 112C adds a menu item (in this case, “music playback” item) in the menu to allow the user to select the downloaded application.

When the user selects the item for selection of the external application, associated information is supplied to the interface module 112C so that the interface module 112C starts the selected external application. The function menu of the selected external application is displayed in top left corner of the screen as shown in FIG. 19. For example, when the music playback application module 113 is started, a menu is displayed including the following menu items: an “UP” button and a “DOWN” button for selection of music; a music menu listing pieces of music; a “download other music” menu item for downloading other pieces of music; a “playback” menu item for playing back the selected piece of music; and a “stop” menu item for stopping the playback. When one of the item is selected by the user, associated information is supplied to the interface module 112C so that the interface module 112C executes the service corresponding to the selected item.

The other aspects of the operation according to the tenth embodiment are substantially identical to the corresponding aspects according to the third embodiment so that the description thereof is omitted.

As has been described, according to the tenth embodiment, the music playback application module 113 is downloaded from the server 37 in addition to the distribution application module 111 so that an optional service of music playback is available to the user.

Eleventh Embodiment

The description given above of the first through tenth embodiment discusses cooperation between the distribution application, used in the collection and delivery operation, and the navigation application module. By allowing the navigation application module to cooperate with a taxi allocation support application module instead of the distribution application module, the present invention finds an application in the building of a taxi allocation support system.

Twelfth Embodiment

Similarly, by allowing the navigation application module to cooperate with an application module for supporting inspection of, for example, waterworks facilities, an inspection operation support system may be build.

Thirteenth Embodiment

Similarly, by allowing the navigation application module to cooperate with an application module for supporting fire fighting activities, a fire fighting activity support system may be build.

Fourteenth Embodiment

Similarly, by allowing the navigation application module to cooperate with an application module for supporting police activities, a police activity support system may be built.

Fifteenth Embodiment

The description of the eighth embodiment discusses downloading of the distribution application (optional application processing block). Alternatively, the interface module (interface processing block) may be downloaded.

The present invention is not limited to the above-described embodiments, and variations and modifications may be made without departing from the scope of the present invention.

What is claimed is:

1. A navigation apparatus for providing navigation services, comprising:
a platform block provided with hardware of the navigation apparatus and basic functions for controlling the hardware;
a navigation application processing block for providing navigation services using the basic functions provided in said platform block; and
an optional application processing block for providing optional services using any of the navigation services based on information acquired using the basic functions of said platform block, by communicating with said navigation application processing block.

2. The navigation apparatus according to claim 1, wherein said optional application processing block is an application executed on a virtual platform and is independent of said platform block.

3. The navigation apparatus according to claim 1, wherein said optional application processing block is a Java application executed on a Java virtual machine, and
said navigation application processing block communicates with said optional application processing block in accordance with Java native interface.

4. The navigation apparatus according to claim 1, wherein said navigation application processing block communicates with said optional application processing block using socket communication.

5. A computable readable recording medium storing programs for controlling a computer to operate as a navigation apparatus providing navigation services, the programs allowing a computer to operate as:
a platform block provided with basic functions for controlling hardware of the navigation apparatus;
a navigation application processing block for providing navigation services using the basic functions of the platform block; and
an optional application processing block for providing optional services using any of the navigation services based on information acquired using the basic functions of said platform block, by communicating with said navigation application processing block.

6. A navigation apparatus for providing navigation services, comprising:
a platform block provided with hardware of the navigation apparatus and basic functions for controlling the hardware;
a navigation application processing block for providing navigation services using the basic functions provided in said platform block;
an optional application processing block for providing optional services using any of the navigation services based on information acquired using the basic functions of said platform block; and
an interface processing block for communicating with said optional application processing block and said navigation application processing block so as to enable any of the optional services to be executed.

7. The navigation apparatus according to claim 6, wherein said optional application processing block is executed on a virtual platform and is independent of said platform.

8. The navigation apparatus according to claim 6, wherein said optional application processing block is a Java application executed on a Java virtual machine.

9. The navigation apparatus according to claim 6, wherein said interface application block is a Java application executed on a Java virtual machine.

10. The navigation apparatus according to claim 9, wherein said interface application block is provided with one of a method for exchanging data with said optional application processing block and a member variable in which said optional application processing block reads and writes data, and one of a method for exchanging data with said navigation application processing block and a member variable in which said navigation application processing block reads and writes data.

11. The navigation apparatus according to claim 6, wherein said navigation application processing block executes any of the navigation services in accordance with navigation control data supplied from said optional application processing block via said interface processing block and supplies navigation information data including an interim result or an execution result to said optional application processing block via said interface processing block.

12. The navigation apparatus according to claim 11, wherein said interface processing block generates, when it is determined that the navigation control data from said optional application processing block is composite navigation control data, plural navigation control data sets from the composite navigation control data and supplies the plural navigation control data sets to said navigation application processing block.

13. The navigation apparatus according to claim 6, wherein said interface processing block communicates with said optional application processing block using socket communication or Java RMI.

14. The navigation apparatus according to claim 6, wherein said interface processing block communicates with said navigation application processing block using socket communication.

15. The navigation apparatus according to claim 6, wherein said interface processing block acquires a remote optional application processing block from an external source using the basic functions of said platform block.

16. The navigation apparatus according to claim 15, wherein said interface processing block acquires the remote optional application processing block from the external source only when a communication service used by the remote optional application processing block is available for use.

17. The navigation apparatus according to claim 15, wherein said interface processing block displays a menu of remote optional application processing blocks using the basic functions of said platform block, adds to the menu the remote optional application processing block when the remote optional application processing block is acquired from the external source and starts the acquired remote optional application processing block when selected from the menu.

18. The navigation apparatus according to claim 6, wherein said optional application processing block supplies a request for required communication services to said interface processing block, and
said interface processing block dynamically starts the requested communication services upon receipt of the request.

19. The navigation apparatus according to claim 18, wherein said interface processing block acquires a module for executing the requested communication services corresponding to the request when the module is not available.

20. The navigation apparatus according to claim 6, wherein said optional application processing block provides collection and delivery information services using any of the navigation services, based on information acquired from a predetermined center using the basic functions of said platform block.
